(19) United States
(12) Patent Application Publication
(10) Pub. No.: US 2014/0067603 A1
(43) Pub. Date: Mar. 6, 2014

(54) ONLINE MARKETPLACE FOR WHOLESALE DEALS

(71) Applicants: Anthony Okoro, San Jose, CA (US); Andrews Punnoose, San Jose, CA (US); Richard Prabu Doss, Campbell, CA (US); Nathalie Walton, San Francisco, CA (US); Jeremy Mark Walton, Campbell, CA (US); Edward Wexler-Beron, Portola Valley, CA (US)

(72) Inventors: Anthony Okoro, San Jose, CA (US); Andrews Punnoose, San Jose, CA (US); Richard Prabu Doss, Campbell, CA (US); Nathalie Walton, San Francisco, CA (US); Jeremy Mark Walton, Campbell, CA (US); Edward Wexler-Beron, Portola Valley, CA (US)

(21) Appl. No.: 13/601,825

(22) Filed: Aug. 31, 2012

(51) Int. Cl. G06Q 30/06

(52) U.S. Cl. CPC G06Q 30/0609
USPC 705/26.35

(57) ABSTRACT

A method of vetting a wholesaler of an item for participation in an online marketplace is disclosed. A notification that the wholesaler of the item intends to sell the item on the online marketplace is received. The online marketplace is reserved for wholesaling and the notification includes a price at which the wholesaler intends to sell the item. The price at which the wholesaler intends to sell the item is compared with an average price at which an end consumer may purchase the item on an additional online marketplace. The additional online marketplace is not reserved for wholesaling. A listing is received from a wholesaler of the item on the online marketplace based on the comparison of the price at which the wholesaler intends to sell the item being less than the average price at which the end consumer may purchase the item on the additional online marketplace.

### TECHNICAL FIELD

The present application relates generally to the technical field of managing communications over a network, and, in one specific example, to allowing wholesalers to communicate with selected potential buyers regarding listings of items on an online marketplace.

### BACKGROUND

Various network-based publication systems (e.g., EBAY®, AMAZON®, or CRAIGSLIST®) facilitate the buying or selling of items (e.g., goods or services) by their users. However, these network-based publication systems, which typically focus on facilitating deals between sellers and end consumers, often do not cater to various needs or desires of wholesalers.

### BRIEF DESCRIPTION OF THE DRAWINGS

Some embodiments are illustrated by way of example and not limitation in the figures of the accompanying drawings in which:

FIG. 1 is a network diagram depicting a system within which various example embodiments may be deployed.

FIG. 2 is a block diagram illustrating example modules of the applications of FIG. 1.

FIG. 3 is a flowchart illustrating an example method of vetting a wholesaler prior to allowing the wholesaler to access an online marketplace to make wholesale deals.

FIG. 4 is a flowchart illustrating an example method of allowing a potential buyer to access an online marketplace reserved for wholesale deals.

FIG. 5 is a flowchart illustrating an example method of allowing a wholesaler and a potential buyer to engage in negotiations for a sale of the item at a quantity or price that is not offered by the wholesaler in a listing of the item on an online marketplace.

FIG. 6 is a flowchart illustrating an example method of allowing a buyer or a seller to manage a plurality of active negotiations on an online marketplace.

FIG. 7 is a flowchart illustrating an example method of selecting a listing for presentation as a featured listing to potential buyers.

FIG. 8 is a flowchart illustrating an example method of allowing a wholesaler to restrict an offer for a sale of an item to certified resellers.

FIG. 9 is a flowchart illustrating an example method of determining a price for a quantity of items to be purchased by a potential buyer based on volume pricing submitted by a wholesaler.

FIG. 10 is a screenshot of a portion of an example user interface that a wholesaler or a potential buyer may be presented with upon seeking access to an online marketplace for facilitating wholesale deals.

FIG. 11 is a screenshot of a portion of an example user interface that may be presented in order to collect information from the wholesaler about an item that the wholesaler intends to list on the online marketplace.

FIG. 12 is a screenshot of a portion of an example user interface that may be presented in order to collect information from the wholesaler about a mixed lot of items that the wholesaler intends to list on the online marketplace.

FIG. 13 is a screenshot of a portion of an example user interface that may be presented in order to collect additional information from the wholesaler about an item or mixed lot of items that the wholesaler intends to list on the online marketplace.

FIG. 14 is a screenshot of a portion of an example user interface that may be presented in order to collect shipping information from the wholesaler about an item or mixed lot of items that the wholesaler intends to list on the online marketplace.

FIG. 15 is a screenshot of a portion of an example user interface of a listing of an item that may be presented to a potential buyer of the item.

FIG. 16 is a screenshot of a portion of an example user interface that may be presented to a wholesaler to allow the wholesaler to view information about or perform actions with respect to one or more listings.

FIG. 17 is a screenshot of a portion of an example user interface that may be presented to a potential buyer to allow the potential buyer to view listings on the online marketplace.

FIG. 18 is a screenshot of a portion of an example user interface that may be presented to a potential buyer to allow the potential buyer to view listings on the online marketplace.

FIG. 19 is a screenshot of a portion of an example user interface that may be presented to a potential buyer to allow the potential buyer to negotiate with a wholesaler of an item.

FIG. 20 is a screenshot of a portion of an example user interface that may be presented to a potential buyer or wholesaler to allow the potential buyer or wholesaler to the view the status of and perform actions with respect to ongoing negotiations for one or more items.

FIG. 21 is a screenshot of a portion of an example user interface that may be presented to a potential buyer or wholesaler when the potential buyer or wholesaler intends to make a counter offer during the negotiation process.

FIG. 22 is a screenshot of a portion of an example user interface that may be presented to a potential buyer to allow the potential buyer negotiate a shipping price separately from an item price and an item quantity.

FIG. 23 is a screenshot of a portion of an example user interface that may be presented to a potential buyer to allow the potential buyer to provide evidence that the potential buyer is a certified reseller.

FIG. 24 is a screenshot of a portion of an example user interface that may be presented to a wholesaler to collect information about a wholesaler or potential buyer, such as default preferences of the wholesaler or potential buyer.

FIG. 25 is a screenshot of a portion of an example user interface that may be presented to allow an administrator to manage users with respect to the online marketplace system.

FIG. 26 is a screenshot of a portion of an example user interface that may be presented to allow an administrator to manage listings on the online marketplace system.

FIG. 27 is a screenshot of a portion of an example user interface that may be presented to allow an administrator to manage orders on the online marketplace system.

FIG. 28 is a screenshot of a portion of an example user interface that may be presented to allow an administrator to manage conversations between users of the online marketplace system.

FIG. 29 is a screenshot of a portion of an example user interface that may be presented to allow an administrator to manage settings of the online marketplace system.

FIG. 30 is a screenshot of a portion of an example user interface that may be presented to allow an administrator to perform miscellaneous actions with respect to the online marketplace system.

FIG. 31 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Consistent with various embodiments, a method of vetting a wholesaler of an item for participation in an online marketplace is disclosed. A notification that the wholesaler of the item intends to sell the item on the online marketplace is received. The online marketplace is reserved for wholesaling and the notification includes a price at which the wholesaler intends to sell the item. The price at which the wholesaler intends to sell the item is compared with an average price at which an end consumer may purchase the item on an additional online marketplace. The additional online marketplace is not reserved for wholesaling. A listing is received from a wholesaler of the item on the online marketplace based on the comparison of the price at which the wholesaler intends to sell the item being less than the average price at which the end consumer may purchase the item on the additional online marketplace.

This method and the various embodiments disclosed herein may be implemented as a computer system having one or more modules (e.g., hardware modules or software modules). This method and the various embodiments disclosed herein may be embodied as instructions stored on a machine-readable medium that, when executed by a processor, cause the processor to perform the method.

As used herein, a wholesaler is an entity (e.g., a person or business) that sells items (e.g., goods or services) to potential buyers who are not end consumers of the items. A wholesale deal is a deal between a wholesaler and a potential buyer (e.g., an agreement by a potential buyer to purchase an item from a wholesaler). Furthermore, the term “reseller” may be used interchangeably with the term “wholesaler.”

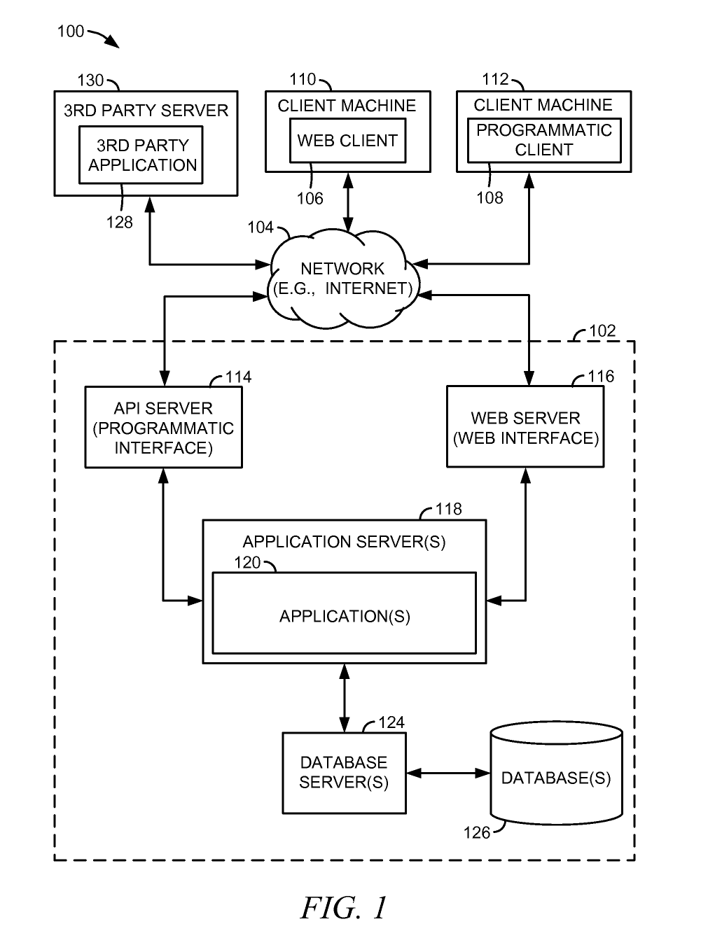

FIG. 1 is a network diagram depicting a system 100 within which various example embodiments may be deployed. A networked system 102, in the example forms of a network-based marketplace or other publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112. Each of the one or more clients may include a software application module (e.g., a plug-in, add-in, or macro) that adds a specific service or feature to a larger system.

An API server 114 and a web server 116 are coupled to, and provide programmatic and web interfaces respectively to, one or more application servers 118. The application servers 118 host one or more applications. The application servers 118 are, in turn, shown to be coupled to one or more database servers 124 that facilitate access to one or more databases 126 or “not only SQL” (NoSQL) or non-relational data stores.

The marketplace applications 120 may provide a number of marketplace functions and services to users that access the networked system 102. While the applications 120 are shown in FIG. 1 to form part of the networked system 102, in alternative embodiments, the applications 120 may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various marketplace and applications 120 could also be implemented as standalone software programs, which do not necessarily have networking capabilities. Additionally, although FIG. 1 depicts machines 130, 110, and 112 as being coupled to a single networked system 102, it will be readily apparent to one skilled in the art that machines 130, 110, and 112, as well as applications 128, 106, and 108, may be coupled to multiple networked systems. For example, the application 128, 106, and 108 may be coupled to multiple payment applications, such as payment applications associated with multiple payment processors (e.g., Visa, MasterCard, and American Express).

The web client 106 accesses the various applications 120 via the web interface supported by the web server 116. Similarly, the programmatic client 108 accesses the various services and functions provided by the applications 120 via the programmatic interface provided by the API server 114. The programmatic client 108 may, for example, be a seller application (e.g., the TurboLister application developed by eBay Inc., of San Jose, Calif.) to allow sellers to author and manage listings on the networked system 102 in an off-line manner, and to perform batch-mode communications between the programmatic client 108 and the networked system 102.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, marketplace or payment functions that are supported by the relevant applications of the networked system 102.

The applications 120, described in more detail below, may facilitate the making of deals between wholesalers and potential buyers. For example, the applications 120 may provide an online marketplace to which access is restricted to wholesalers who are able to offer items for sale in bulk at a significant discount or potential buyers of such items that are identified as also being top sellers of the items to end consumers. The applications 120 may further provide functions within an online marketplace that are specifically targeted to wholesale deals, such as functions allowing wholesalers to restrict their offers for sales of items to certified wholesalers, functions allowing volume discounting, functions allowing negotiations for custom deals between wholesalers and potential buyers, functions allowing management or tracking of active deal-making in progress, and so on, as described in more detail below.

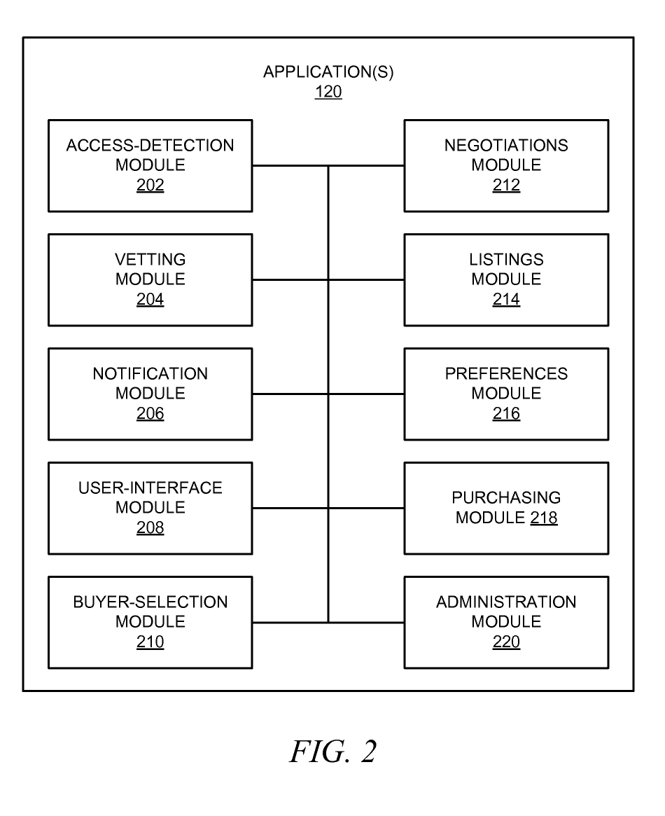

FIG. 2 is a block diagram illustrating example modules of the applications 120. An access-detection module 202 detects that a wholesaler or potential buyer is attempting to access an online marketplace reserved for wholesaling. A vetting module 204 determines whether to allow the potential buyer or the wholesaler to gain access to the online marketplace or perform various actions after gaining access to the online marketplace based on various criteria, as described in more detail below. A notification module 206 provides notifications to the wholesalers or potential buyers (e.g., regarding actions other users of the online marketplace have performed). A user interface module 208 presents various user interfaces to the wholesalers or potential buyers. A buyer-selection module 210 selects one or more potential buyers from multiple candidate buyers to access the online marketplace. A negotiations module 212 facilitates negotiations between wholesalers and potential buyers. A listings module 214 generates listings for items based in information provided about the items by the wholesalers. A preferences module 216 determines preferences of wholesalers or potential buyers. A purchasing module 218 allows a potential buyer to agree to purchase an item from a wholesaler at an agreed-upon price, quantity, and shipping price and facilitates a transaction between the potential buyer and the wholesaler. An administration module 220 allows an administrator of the online marketplace to perform various administrative tasks, such as providing new users (e.g., wholesalers or potential buyers) with access to the online marketplace, approving listings as featured listings, or monitoring orders, negotiations, or conversations between users.

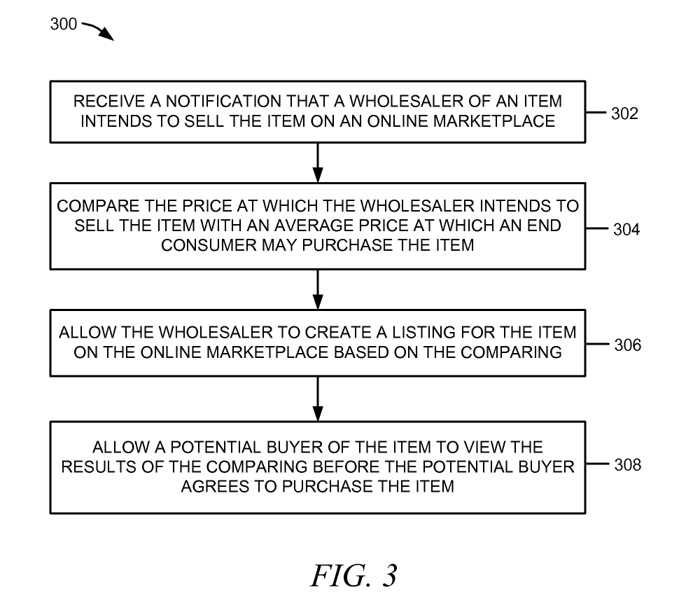

FIG. 3 is a flowchart illustrating an example method 300 of vetting a wholesaler prior to allowing the wholesaler to access an online marketplace (e.g., the networked system 102 of FIG. 1) to make wholesale deals. Various operations of the method 300 may be performed by the applications 120 illustrated in FIGS. 1 and 2. At operation 302, the access module 202 receives a notification that a wholesaler of an item intends to sell the item on the online marketplace. In various embodiments, the online marketplace facilitates the making of wholesale deals between wholesalers and potential buyers, but not between sellers and end consumers. Thus, the access module 202 may restrict access to the online marketplace to entities seeking to make wholesale deals only. In various embodiments, the notification includes a price (e.g., a price per unit) at which the wholesaler intends to sell the item on the online marketplace.

At operation 304, the vetting module 204 compares the price at which the wholesaler intends to sell the item with an average price at which an end consumer may purchase the item on an additional online marketplace. Here, the additional online marketplace may be an online marketplace that facilitates deal-making between sellers and end consumers of an item (e.g., e.g., EBAY®, AMAZON®, or CRAIGSLIST®). In various embodiments, the vetting module 204 determines the average price at which an end consumer may purchase the item by accessing the additional online marketplace via a URL that includes a string identifying the item in a format recognized by the additional online marketplace. For example, the vetting module 204 may access live listings on the additional online marketplace using an HTTP request that includes a string that contains the title of a listing corresponding to the item (or other identifier of the listing). Thus, in various embodiments, the vetting module 204 may determine the average price of the item on the additional online marketplace by generating and accessing a URL that is used on the additional online marketplace to access listings for that item. For example, to access listings for an item on eBay, the vetting module 204 may generate a URL that is specific to eBay, such as “http://www.ebay.com/sch/i.html?_kw=keywords,” wherein keywords are keywords that identify listings for the item on eBay. Thus, the vetting module 204 may perform the comparison of prices of listings without using a crawler that stores results in a database or an API provided by the additional online marketplace. In other embodiments, the vetting module 204 may determine the average price of the item by using a crawler or calling an API of the additional online marketplace.

At operation 306, the vetting module 204 allows the wholesaler to provide information for creating or updating a listing for the item (e.g., via the listings module 214) on the online marketplace based on the comparing of the price at which the wholesaler intends to sell the item being less than the average price at which the end consumer may purchase the item on the additional online marketplace. In various embodiments, the vetting module 204 may allow the wholesaler to list the item on the online marketplace based on a difference between the price at which the wholesaler intends to sell and the price at which the end consumer may purchase the item on the additional marketplace. In some embodiments, the difference may be compared to a threshold that, if met or exceeded, indicates that the wholesaler is allowed to list the item in the online marketplace. For example, the vetting module 204 may allow the wholesaler to create the listing based on the wholesaler offering the item for sale at a 20% discount over the average price at which end consumers may purchase the item on the additional online marketplace. In various embodiments, the vetting module 204 may allow the wholesaler to create the listing based on a calculation of commissions that an operator of the online marketplace is likely to receive based on anticipated sales of the item on the online marketplace. The calculation may be based on information maintained on the online marketplace or the additional online marketplace with respect to supply or demand of the item. In some cases, the calculation may be based on a size of a commission that the wholesaler will pay upon the sales of the individual item.

At operation 308, the user interface module 208 allows a potential buyer of the item on the online marketplace to view the average price at which an end consumer may purchase the item on the additional online marketplace. For example, the user interface module 208 may present a user interface to the potential buyer that includes a user interface element (e.g., a “Compare Prices” button) in conjunction with a display of the listing of the item. When the user interacts with the user interface element (e.g., when the user clicks the button), the user interface module 208 may display results of the identification of the average price that an end consumer may pay for the item as performed by the vetting module 204 (see operation 404 above). For example, the user interface module 208 may present a list of prices at which the item has recently sold or is currently available to be sold to end consumers on eBay. In this way, the potential buyer of the item from the wholesaler will be able to confirm an amount of savings that the potential buyer will receive by buying the item from the wholesaler.

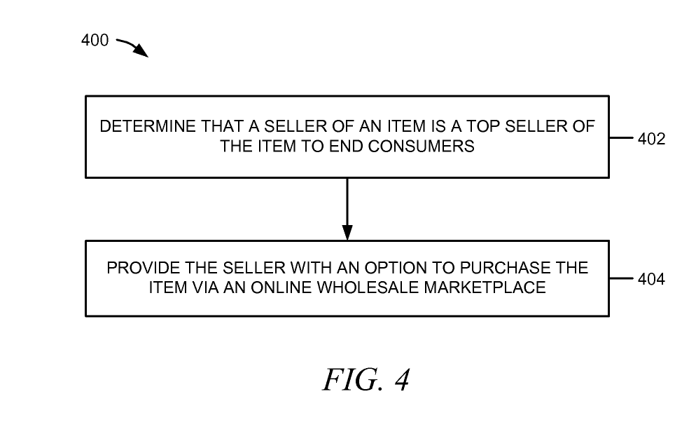

FIG. 4 is a flowchart illustrating an example method 400 of allowing a potential wholesale buyer to access an online marketplace reserved for wholesale deals. In some instances, the wholesale buyer later sells the purchased wholesale items to end consumers in another online marketplace. The identified buyer may later act as a seller in the other online marketplace. Various operations of the method 400 may be performed by the applications 120 illustrated in FIGS. 1 and 2. At operation 402, the buyer-selection module 210 determines that an identified buyer of is a top seller of the item on the other marketplace. For example, the buyer-selection module 210 may determine that an identified buyer is in the top 10% of sellers with respect to units of the item sold on the other marketplace. Or the buyer-selection module 210 may determine that the identified buyer is in the top 10% in terms of feedback rating received from end consumers to which the identified buyer has sold the item on the other online marketplace. Here, the other online marketplace is not reserved for wholesaling; instead, it facilitates sales between sellers and end consumers.

At operation 404, the vetting module 204 provides the identified wholesale buyer with an option to access the online marketplace reserved for wholesaling (e.g., to purchase the item from a wholesaler). For example, the vetting module 204 sends an email message to the wholesale buyer that includes a code that the wholesale buyer can use to gain access to the online wholesale marketplace (e.g., to view listings on the wholesale online marketplace that pertain to the item and to negotiate for the purchasing of the item from a wholesaler). In various embodiments, the online wholesale marketplace is reserved for wholesaling. In various embodiments, the vetting module 204 may vet the buyer to confirm that the buyer is a certified reseller (as described in more detail below).

In various embodiments, the vetting module 204 provides potential buyers of items from wholesalers with access to items offered for sale on the online wholesale marketplace in addition to the item that the potential buyer is a top seller of on the other online wholesale marketplace. Thus, even if the potential buyer is selected to access the online wholesale marketplace based on the potential buyer being a top seller of a particular the item to end consumers, the potential buyer may be able to view listings pertaining to all or a subset of the items listed offered for sale on the online wholesale marketplace.

In various embodiments, the vetting module 204 provides different potential buyers with different levels of access to the online wholesale marketplace based on various factors. For example, the vetting module 204 may allow Tier 1 potential buyers (e.g., the top 1% of sellers of an item to end consumers on the other online marketplace) access to a listing on the first day it is posted, Tier 2 potential buyers (e.g., the top 5% of sellers of an item to end consumers on the other online marketplace) to access the listing on the second day it is posted, and so on. Or the vetting module 204 may allow all potential buyers to view the listing, but only allow potential buyers to agree to purchase an item that is the subject of the listing based on tier (or priority level) of the potential buyer.

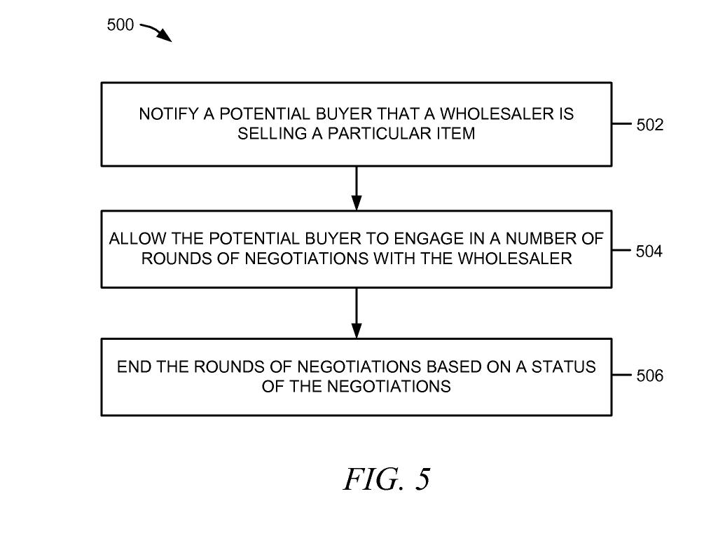

FIG. 5 is a flowchart illustrating an example method 500 of allowing a wholesaler and a potential buyer of an item to engage in negotiations for a sale of the item at a quantity or price that is not offered by the wholesaler in a listing of the item on an online marketplace. Various operations of the method 500 may be performed by the applications 120 illustrated in FIGS. 1 and 2. At operation 502, the notification module 206 notifies a potential buyer that a wholesaler is selling an item. Here, an offer included in the notification specifies one or more quantities and respective prices for the item. For example, the offer specifies that the wholesaler will sell 100 of the items for $1000 or 50 of the items for $700. In various embodiments, the notification module 206 may present the offer (e.g., via the user interface module 208) to the potential buyer in the form of a listing generated using information that is provided by the wholesaler.

At operation 504, the negotiations module 212 allows the potential buyer to engage in a number of rounds of negotiations with the wholesaler regarding the offer. In various embodiments, the number of rounds may be specified by the wholesaler or an administrator of the online marketplace on which the offer for the sale of the item is listed. Additionally, whether the negotiations module 212 allows the potential buyer to engage in any negotiations with the wholesaler may be based on whether the wholesaler has allowed such negotiations (e.g., if the information provided by the wholesaler from which the listing was generated specifies that the wholesaler intends to allow such negotiations for the listing). The negotiations module 212 may, for each of the rounds of negotiations, allow the potential buyer or the wholesaler to propose a different quantity or a different price for the item than the price and quantity that was initially provided by the wholesaler on the listing of the item.

At operation 506, the negotiations module 212 ends the rounds of negotiations based on various factors. For example, the negotiations module 212 may end the negotiations based on the predetermined number of rounds of negotiations concluding without an agreement being reached between the potential buyer and the wholesaler on a final quantity or a final price for the item. Or the negotiations module 212 may end the negotiations based on a wholesaler declining an offer from the buyer without the wholesaler making a counter offer. Or the negotiations module 212 may end the negotiations based on the potential buyer declining an offer from the wholesaler without the buyer making a counter offer. Upon ending the rounds of negotiations, the negotiations module 212 may notify the wholesaler or the potential buyer of the ending of the negotiations. Furthermore, the negotiations module 212 may prevent further access to a user interface (e.g., presented by the user interface module 208) that the wholesaler or the buyer were using to conduct the negotiations.

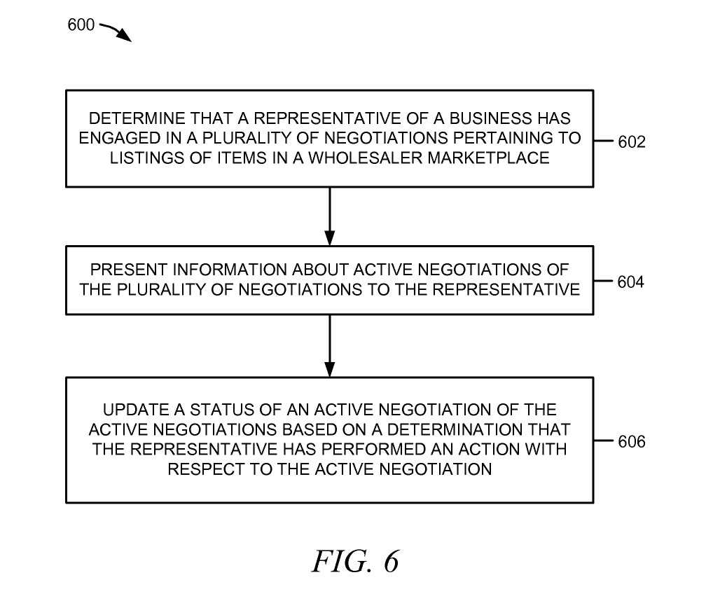

FIG. 6 is a flowchart illustrating an example method 600 of allowing a buyer or a seller to manage a plurality of active negotiations on an online marketplace. Various operations of the method 600 may be performed by the applications 120 illustrated in FIGS. 1 and 2. At operation 602, the negotiations module 212 determines that an entity (e.g., a business or a person) has engaged in a plurality of negotiations pertaining to listings of items in an online marketplace reserved for wholesaling.

At operation 604, the user interface module 208 presents information about active negotiations of the plurality of negotiations to the entity, the information including a status of each active negotiation or an action that is available for the entity to perform with respect to each active negotiation. Such activities may include modifying an offer, ending a negotiation, buying an item (e.g., at a negotiated price and quantity), making a counter offer, and so on.

At operation 606, the user interface module 208 updates a status of an active negotiation of the active negotiations based on a determination that the entity has performed an action with respect to the negotiation. For example, the user interface module 208 changes a status of the active negotiation to “Waiting for wholesaler's response” in response to the entity submitting a counter offer.

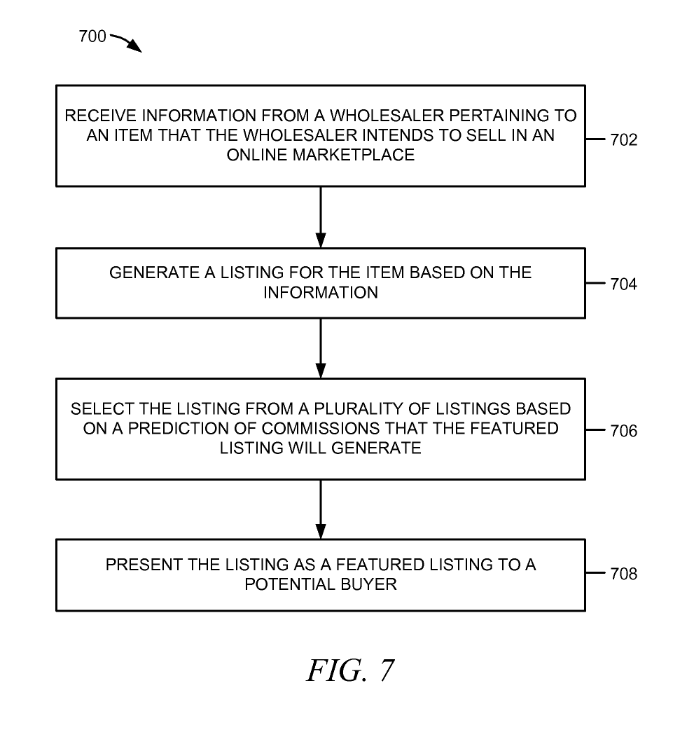

FIG. 7 is a flowchart illustrating an example method 700 of selecting a listing for presentation as a featured listing to potential buyers. Various operations of the method 700 may be performed by the applications 120 illustrated in FIGS. 1 and 2. At operation 702, the listings module 214 receives information from a wholesaler pertaining to an item that the wholesaler intends to sell in an online marketplace. The information may include a lot size, a price per unit, or a number of available lots of the item.

At operation 704, the listings module 214 generates a listing for the item based on the information.

At operation 706, the listings module 214 selects the listings from a plurality of listings (e.g., generated from information about other items submitted by other wholesalers) based on a prediction of commissions that the featured listing will generate (e.g., and that will be paid to an operator of the online marketplace). The prediction may be based on a calculation of various factors, such as the calculation described above with respect to operation 306 of FIG. 3. The calculation may consider the information about the item received from the wholesaler at operation 702.

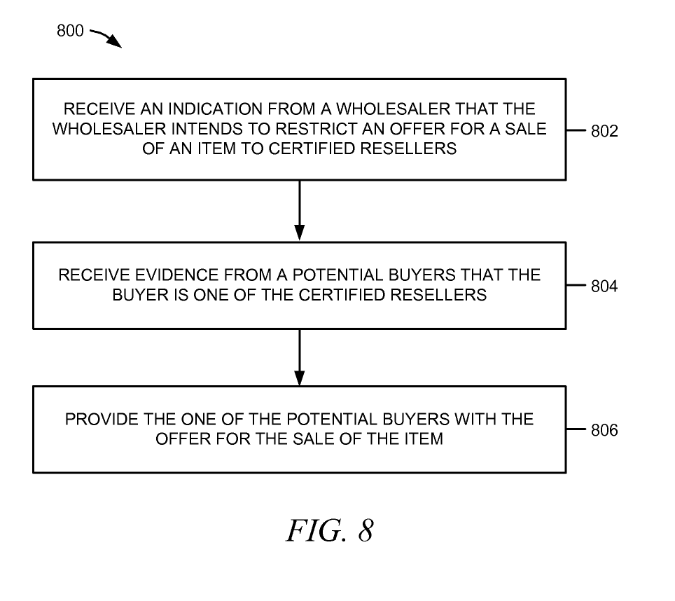

FIG. 8 is a flowchart illustrating an example method 800 of allowing a wholesaler to restrict an offer for a sale of an item to certified resellers. Various operations of the method 800 may be performed by the applications 120 illustrated in FIGS. 1 and 2. At operation 802, the preferences module 216 receives an indication from a wholesaler that the wholesaler wises to restrict an offer for a sale of an item to potential buyers that are certified resellers. For example, the preferences module 216 receives a submission of a form presented to the wholesaler by the user interface module 208 in which the wholesaler has selected an option to restrict offers to certified resellers.

At operation 804, the vetting module 204 receives evidence from one of the potential buyers that the one of the potential buyers is one of the certified resellers. For example, the vetting module 204 receives a submission of a form in which the potential buyer has signed a legal agreement to become a certified reseller or that specifies a reseller ID that has been provided to the potential buyer by a reseller authority (e.g., a government office). In various embodiments, the vetting module 204 authenticates the evidence submitted by the potential buyer (e.g., via a system provided by the reseller authority) based on the evidence submitted by the potential buyer. At operation 806, the vetting module 204 provides the one of the potential buyers with the offer for the sale of the item based on a determination that the one of the potential buyers is the certified reseller.

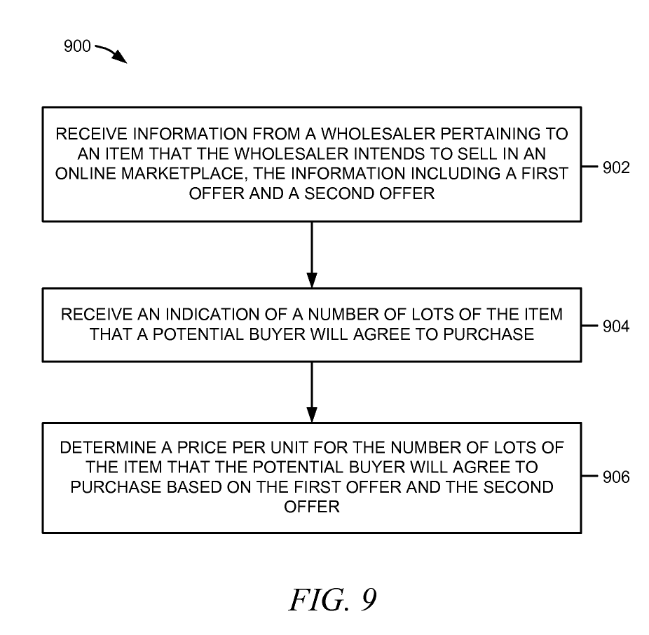

FIG. 9 is a flowchart illustrating an example method 900 of determining a price for a quantity of items to be purchased by a potential buyer based on volume pricing submitted by a wholesaler. Various operations of the method 900 may be performed by the applications 120 illustrated in FIGS. 1 and 2. At operation 902, the listings module 214 receives information from a wholesaler pertaining to an item that the wholesaler intends to sell in an online marketplace. The information includes a first offer and a second offer. The first offer includes a first number of lots of the item and first price per unit for the item. The second offer includes a second number of lots of the item and a second price per unit of the item.

At operation 904, the purchasing module 318 receives an indication of a number of lots of the item that a potential buyer of the item intends to purchase.

At operation 906, the purchasing module 318 determines a price per unit for the number of lots of the item that the potential buyer intends to purchase based on the first offer and the second offer. For example, if the wholesaler specified that he would sell 600 units at $6 per unit and 300 units at $4 per unit, and the potential buyer indicates that he intends to buy 400 units, the purchasing module 318 may determine that the price per unit for the 400 units is $4 per unit based on the number of units being less than the next volume discount level (i.e., 600 units) specified by the wholesaler.

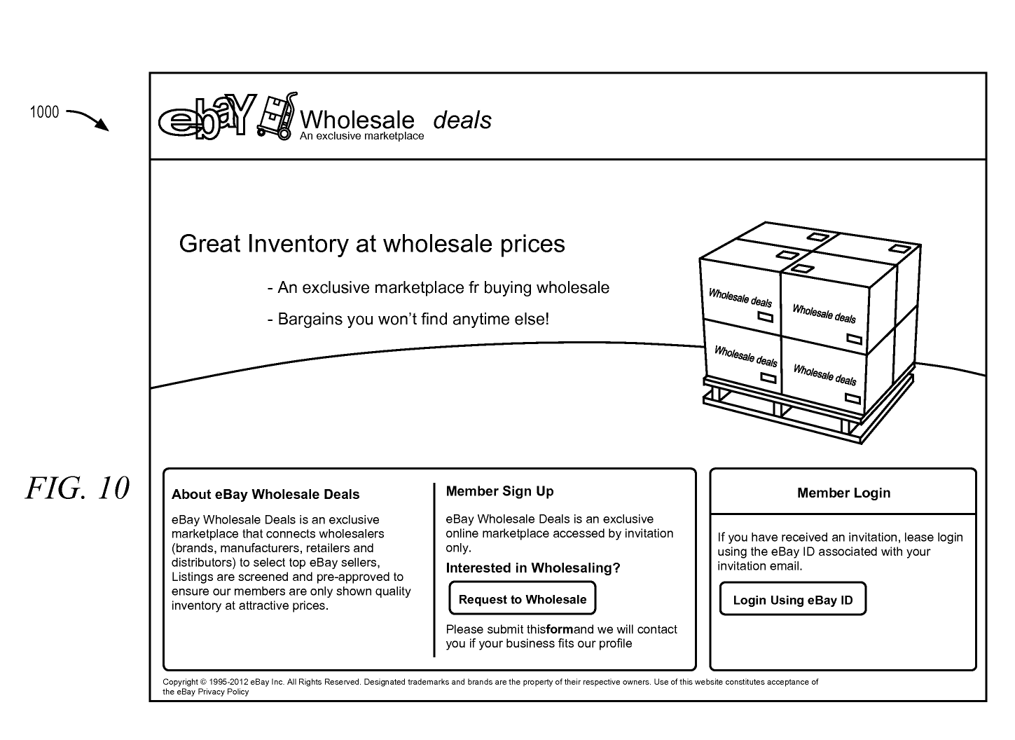

FIG. 10 is a screenshot of a portion of an example user interface 1000 that a wholesaler or a potential buyer may be presented with (e.g., via the user interface module 208) upon seeking access to an online marketplace for facilitating wholesale deals. In various embodiments, access to the online marketplace may be restricted to vetted wholesalers (e.g., as described with respect to FIG. 3) and vetted potential buyers (e.g., as described with respect to FIG. 4).

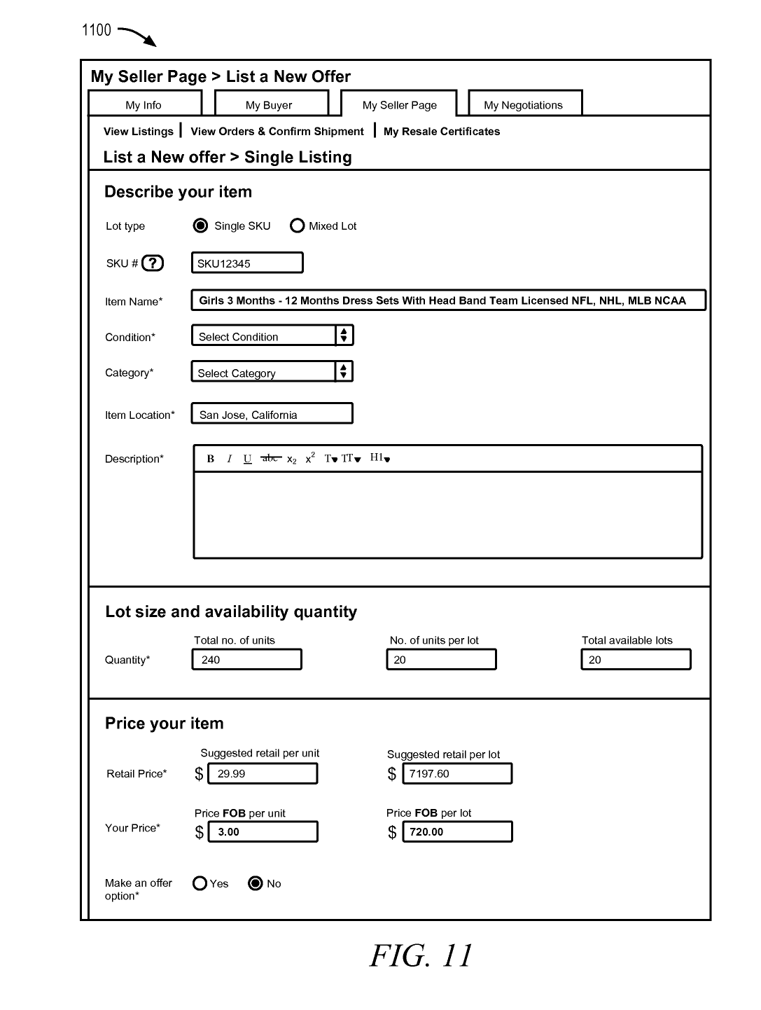

FIG. 11 is a screenshot of a portion of an example user interface 1100 that may be presented (e.g., via the user interface module 208) in order to collect information (e.g., via the listings module 214) from the wholesaler about an item that the wholesaler intends to list on the online marketplace. In various embodiments, this information includes a SKU number, an item name, a condition of the item, a category of the item, a location of the item, a description of the item, an available quantity of the item, a number of units per lot for the item, a number of available lots of the item (e.g., automatically calculated based on available quantity and number of units per lot), a suggested retail price per unit of the item, a suggested retail price per lot (e.g., automatically calculated based on the suggested retail price and available lots) a free-on-board (FOB) price per unit of the item, a FOB price per lot (e.g., automatically calculated based on FOB price per unit and lot size), whether the wholesaler intends to allow potential buyers to make an offer that is different from what is offered by the wholesaler in the listing, and so on. The listings module 214 may generate a listing based on the information provided by the wholesaler and present the listing (e.g., via the user interface module 208) to a potential buyer.

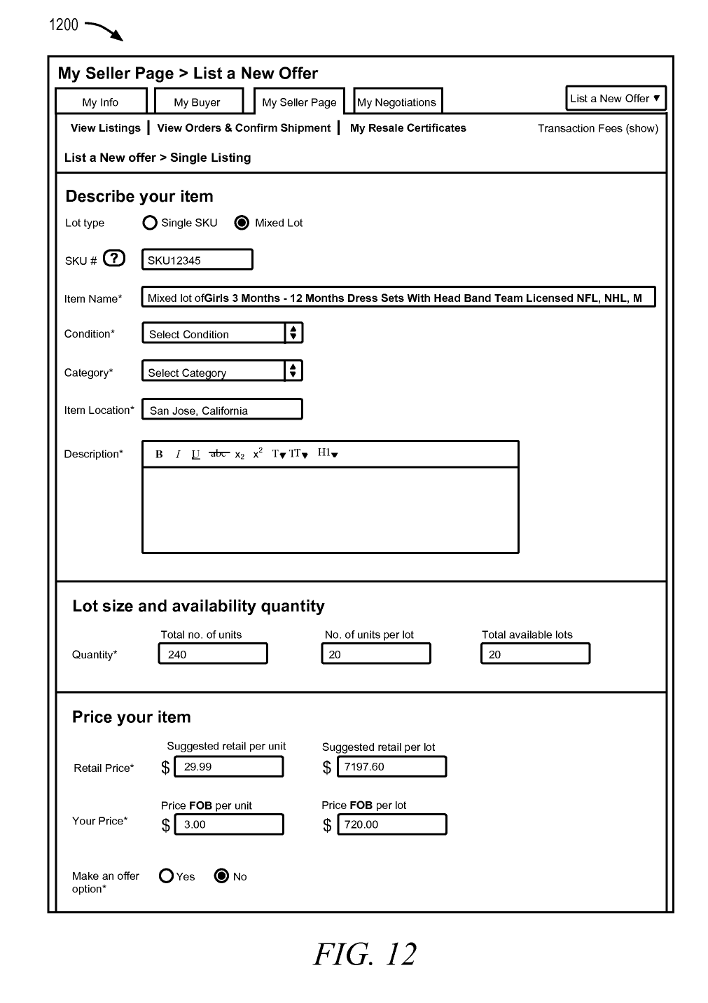

FIG. 12 is a screenshot of a portion of an example user interface 1200 that may be presented (e.g., via the user interface module 208) in order to collect information (e.g., via the listings module 214) from the wholesaler about a mixed lot of items that the wholesaler intends to list on the online marketplace. In various embodiments, the information collected may be the same information that is collected for a listing of a single item (e.g., as described with respect to FIG. 11) except that a SKU number may not be requested. The listings module 316 may generate a listing based on the information provided by the wholesaler and present the listing (e.g., via the user interface module 208) to a potential buyer.

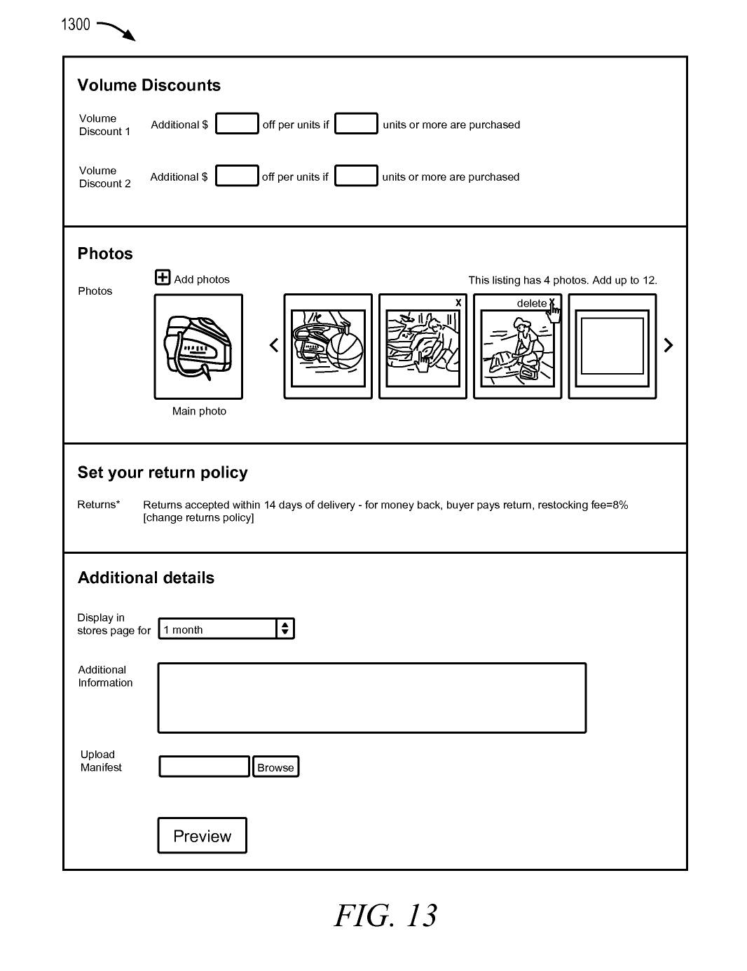

FIG. 13 is a screenshot of a portion of an example user interface 1300 that may be presented (e.g., via the user interface module 208) in order to collect additional information (e.g., via the listings module 214) from the wholesaler about an item or mixed lot of items that the wholesaler intends to list on the online marketplace. The additional information may include information about multiple volume discounts (e.g., a first volume discount that specifies a first amount off per unit if a first number of units or more are purchased and a second volume discount that specifies a second amount off per unit if a second number of units or more are purchased). The additional information may also include one or more photos of the item or mixed lot of items, a return policy for the items, an expiration date for presentation of the item on a store page corresponding to the wholesaler of the item, a manifest listing items included with the shipping of the item, and other additional information. The listings module 214 may include the additional information provided by the wholesaler in a generated listing for the item that is presented (e.g., via the user interface module 208) to a potential buyer.

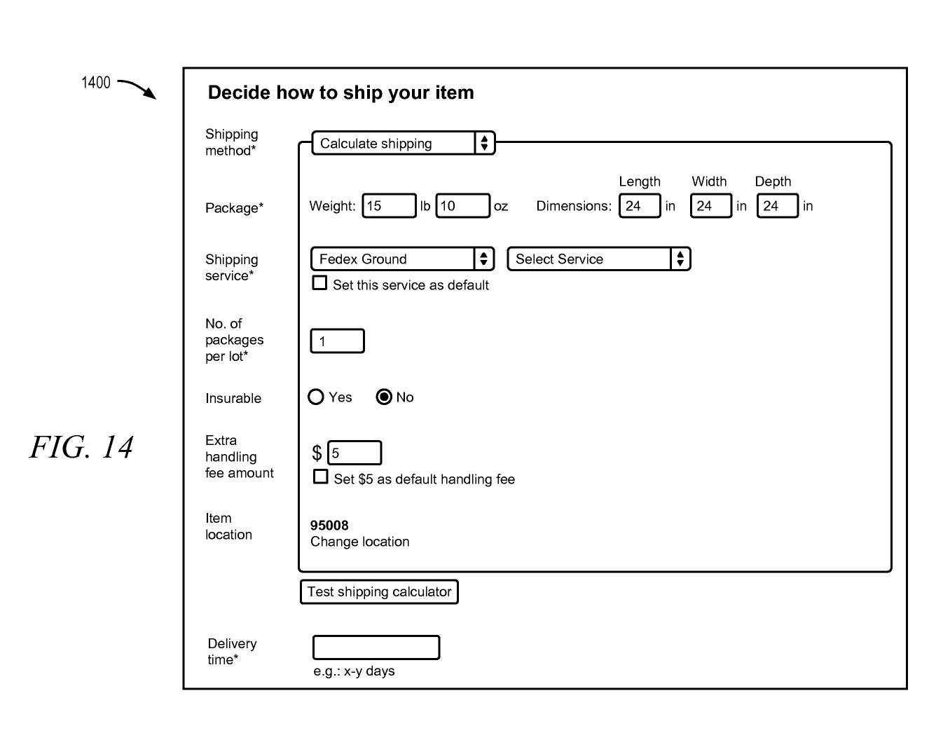

FIG. 14 is a screenshot of a portion of an example user interface 1400 that may be presented (e.g., via the user interface module 208) in order to collect shipping information (e.g., via the listings module 214) from the wholesaler about an item or mixed lot of items that the wholesaler intends to list on the online marketplace. The shipping information may include a shipping method for the item, weight and dimensions of a package containing the item, a shipping service for the item, a number of packages per lot of the item, whether the shipping is insurable, an extra handling fee amount, an item location, and a delivery time for the item.

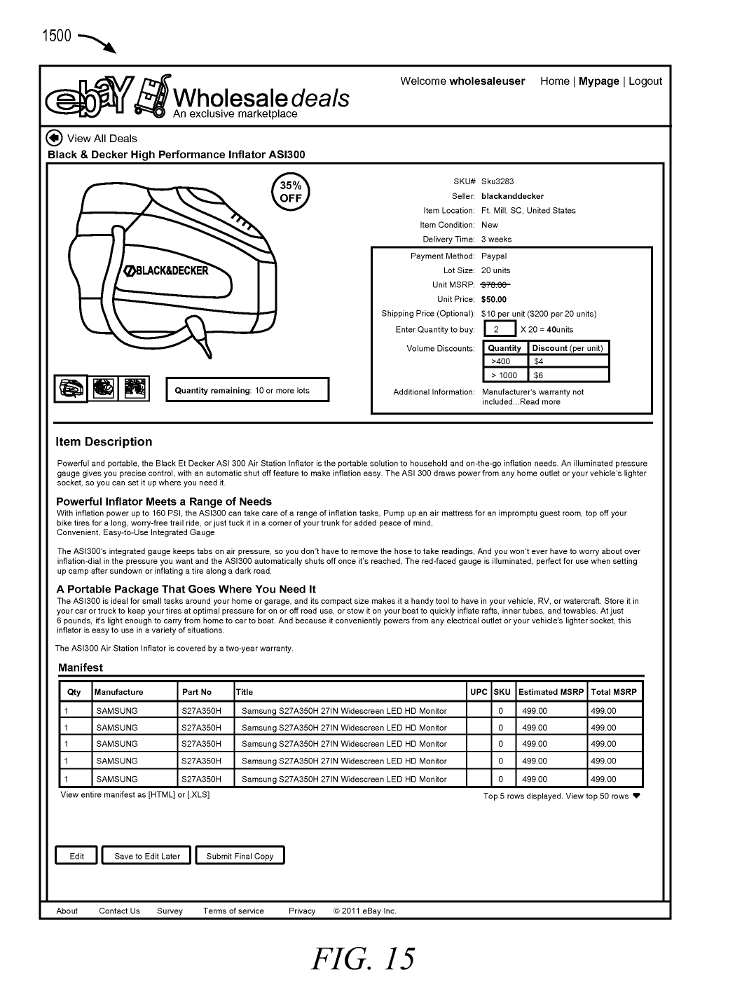

FIG. 15 is a screenshot of a portion of an example user interface 1500 of a listing of an item that may be presented (e.g., via the user interface module 208) to a potential buyer of the item. The listing may include any or all of the information specified by the wholesaler of the item (e.g., as described with respect to FIGS. 11-12). For example, the listing may specify a lot size for the item, volume discounts for the item, and a shipping manifest for the item, and available quantity (e.g., in lots) for the item.

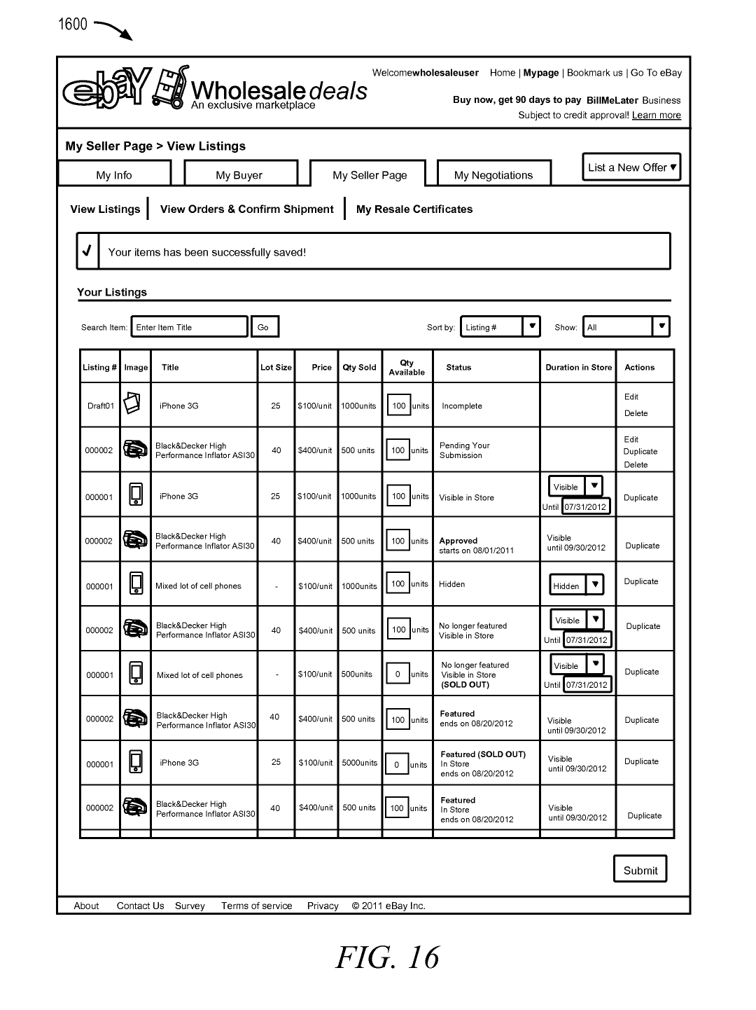

FIG. 16 is a screenshot of a portion of an example user interface 1600 that may be presented (e.g., via the user interface module 208) to a wholesaler to allow the wholesaler to view information about or perform actions with respect to one or more listings. The user interface 1600 may include information about whether an information submission pertaining to a listing is complete or incomplete and provide the wholesaler with the options to edit or delete the information submission. The user interface 1600 may include information about a saved submission that has not yet been submitted such that a listing may be generated (e.g., via the listings module 214) from the information provided in the submission and provide the wholesaler with options to edit, duplicate, or delete the pending submission.

The user interface 1600 may specify that a submission has been approved for listing (e.g., it has passed the vetting process described in FIG. 3) and may allow the wholesaler to specify how long the item is to remain visible to potential buyers. The user interface 1600 may specify that a listing is currently hidden from potential buyers and allow the wholesaler to unhide the listing. The user interface 1600 may specify whether a listing is a featured listing (e.g., as described with respect to FIG. 7) and, if not, provide an option for the wholesaler to resubmit the listing for reconsideration as a featured listing. The user interface 1600 may specify how long a listing will remain as a featured listing, whether the item has sold out, and so on, and provide the wholesaler with an option to request an extension of the listing, set a new expiration date for the visibility of the listing, or duplicate the listing as a new listing. Thus, the status of listings and listing submissions of the wholesaler, as well as access to actions that are available for the user to take to manage the listings and listing submissions, may be presented to the wholesaler on a single screen.

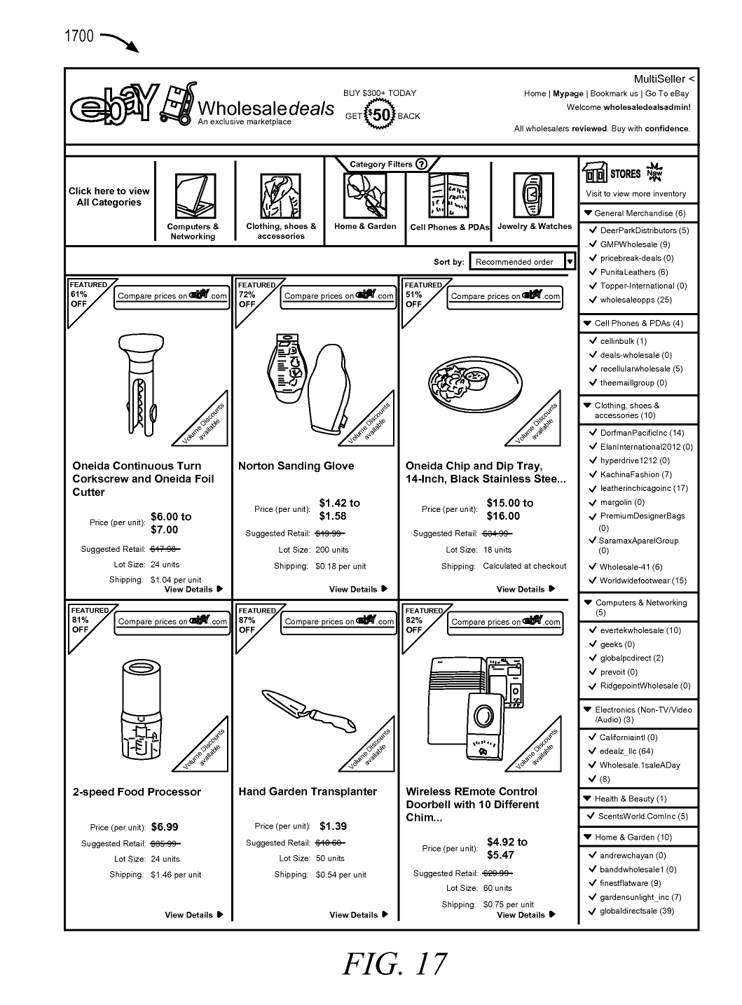

FIG. 17 is a screenshot of a portion of an example user interface 1700 that may be presented (e.g., via the user interface module 208) to a potential buyer to allow the potential buyer to view listings on the online marketplace. The user interface 1700 may include categories by which the potential buyer may filter the listings. Additionally, the listings selected as featured listings may be more prominently displayed than other listings. Each featured listing may specify a discount percentage of the item in relation to the average price of the item available to an end consumer on an additional online marketplace, such as eBay. Additionally, each featured listing may include a “Compare Prices” button or other user interface element that allows the potential buyer to confirm the discount percentage by viewing active or recent listings of the featured item as they appear or recently appeared on the additional marketplace. For example, a potential buyer interested in a wholesaler's offer for a corkscrew listing that is 61% off the average retail price may click the “Compare prices on eBay.com” button to be shown actual active or recent listings of the corkscrew on eBay and an average price associated with those listings. Thus, with a single click on a button associated with the featured item, the potential buyer may confirm that the discount price advertised for the featured item is accurate.

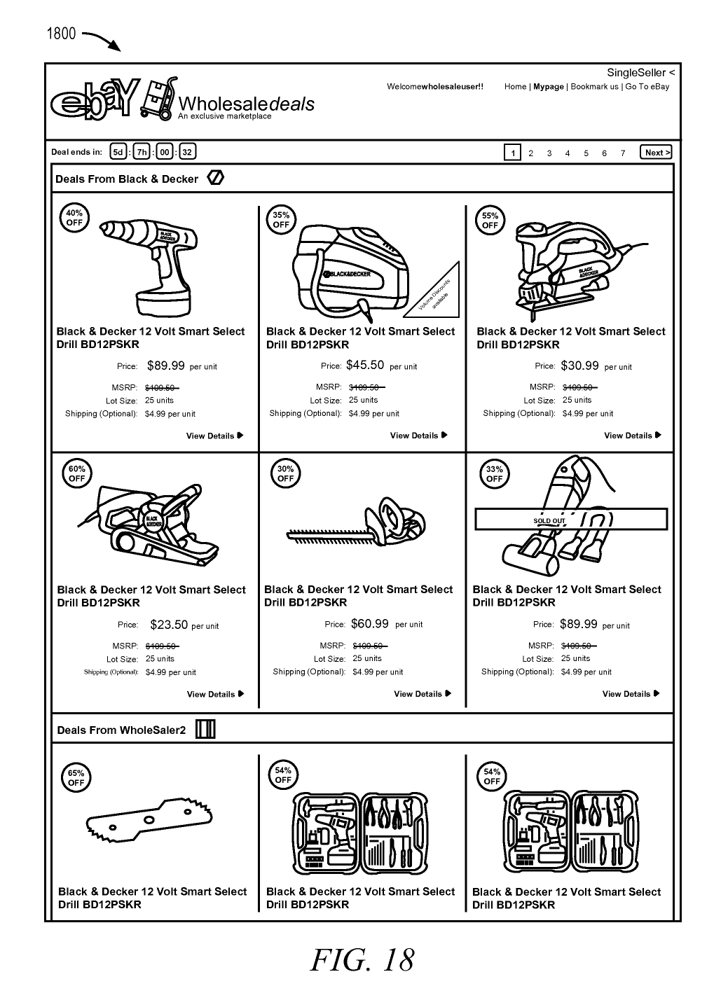

FIG. 18 is a screenshot of a portion of an example user interface 1800 that may be presented (e.g., via the user interface module 208) to a potential buyer to allow the potential buyer to view listings on the online marketplace. The example user interface 1800 may show wholesale deals offered for items matching a search criteria entered by the user (e.g., “Black & Decker”). In various embodiments, the wholesale deals may be organized by wholesaler (e.g., “Deals from Black & Decker,” “Deals from WholeSaler2,” and so on), spanning multiple pages. In various embodiments, the user interface 1800 may display each item of each wholesaler as if they were featured items as selected and presented in user interface 1700 of FIG. 17.

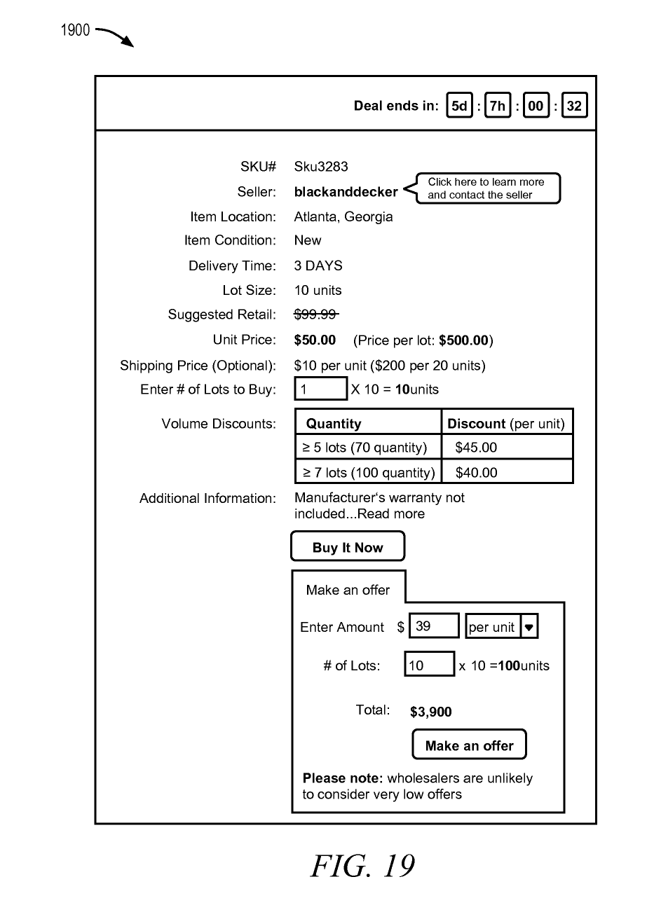

FIG. 19 is a screenshot of a portion of an example user interface 1900 that may be presented (e.g., via the user interface module 208) to a potential buyer to allow the potential buyer to negotiate with a wholesaler of an item. Through the negotiation process, the wholesaler and potential buyer may reach an agreement for a different quantity or different price of the item than what is initially offered by the wholesaler in the listing. In various embodiments, the potential buyer may specify a different amount per unit or a number of lots and submit the offer to the wholesaler for consideration.

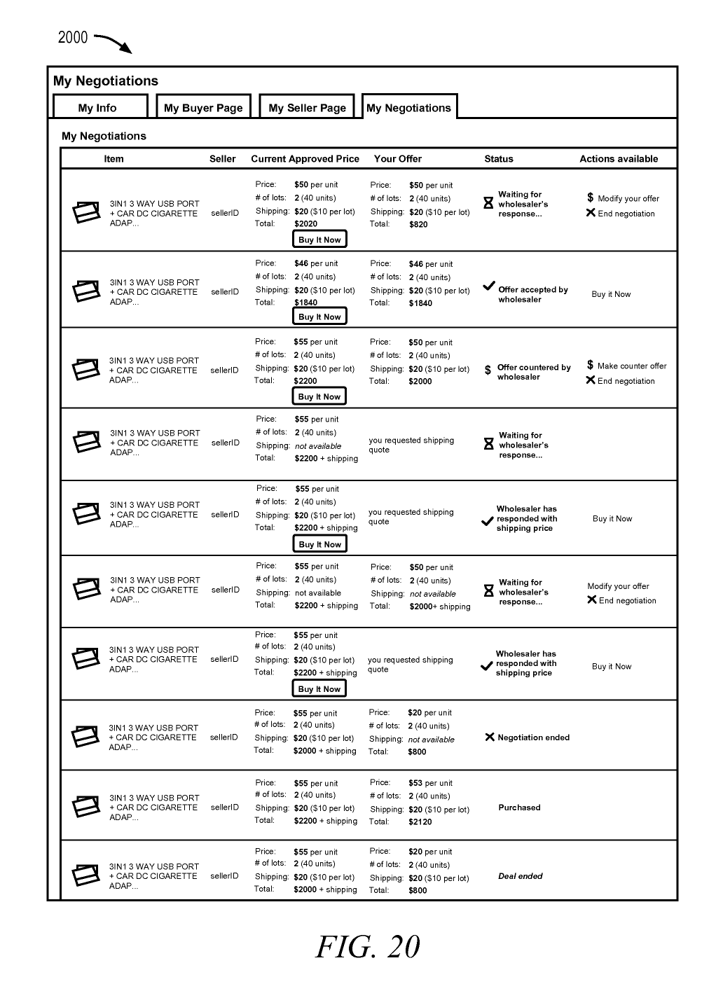

FIG. 20 is a screenshot of a portion of an example user interface 2000 that may be presented (e.g., via the user interface module 108) to a potential buyer or wholesaler to allow the potential buyer or wholesaler to the view the status of and perform actions with respect to ongoing negotiations for one or more items. In various embodiments, the user interface 2000 includes user interface elements (e.g., links) that allow the user to modify an offer, make a counter offer, end a negotiation pertaining to an item, or accept an offer (e.g., “Buy It Now”). Examples of statuses of various negotiations may be “Waiting for wholesaler's response,” “Offer accepted by wholesaler,” “Offer countered by wholesaler,” “Wholesaler has responded with shipping price,” “Negotiation ended,” “Purchased,” “Deal ended,” and so on. Each status may also include a current approved price as well as a price offered by the wholesaler or potential buyers. In various embodiments, the negotiations for the wholesaler acting as buyer and the wholesaler acting as seller may be presented on separate tabs of the user interface 2000.

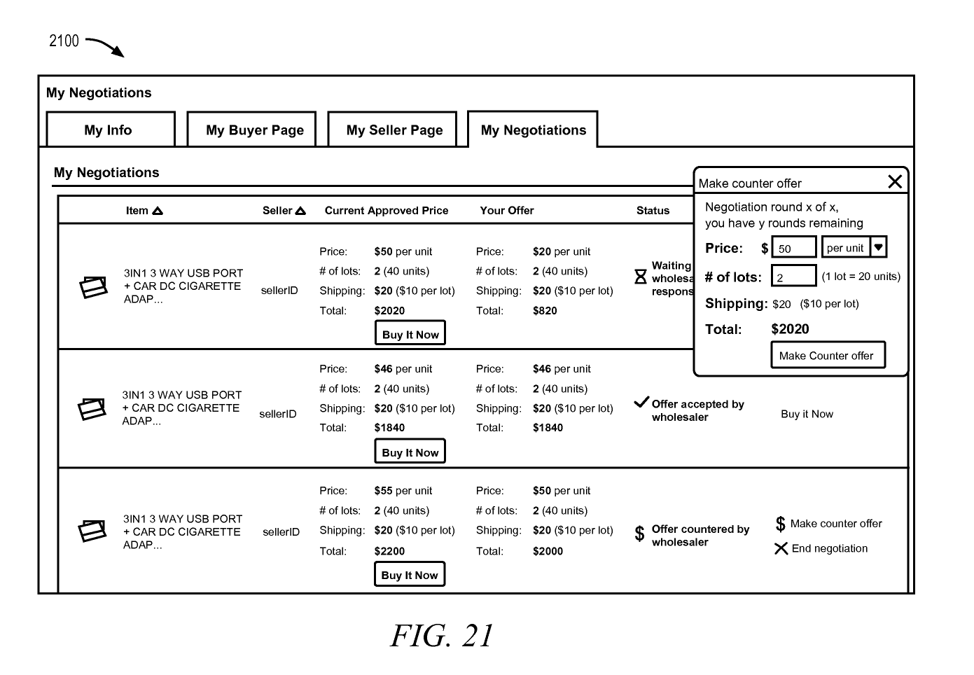

FIG. 21 is a screenshot of a portion of an example user interface 2100 that may be presented (e.g., via the user interface module 208) to a potential buyer or wholesaler when the potential buyer or wholesaler intends to make a counter offer during the negotiation process. The user interface 2100 may highlight the item to which the negotiation applies in a listing of items for which the potential buyer or wholesaler is engaged in negotiations. The user interface 2100 may further specify the current round of the negotiations (e.g., “1”) of a total possible number of rounds of negotiations (e.g., 10) that are allowed (e.g., based on a preference of the wholesaler). The user interface 2100 may include user interface elements into which the wholesaler or potential buyer may specify a new price, number of lots, or shipping price (if the shipping price has not already been agreed to by the potential buyer and seller in a separate negotiation). Upon a submission of a counter offer by one party, the status of the negotiation may be updated in the listing and the other party may be notified of the action taken.

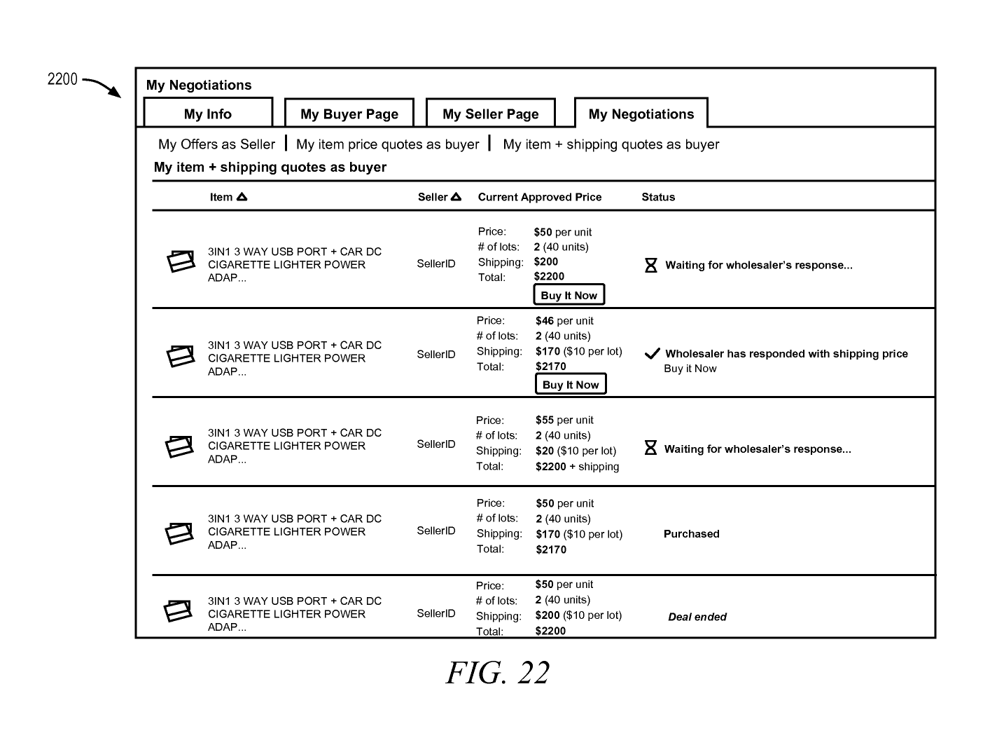

FIG. 22 is a screenshot of a portion of an example user interface 2200 that may be presented (e.g., via the user interface module 208) to a potential buyer to allow the potential buyer to negotiate a shipping price separately from an item price and an item quantity. In various embodiments, the potential buyer may negotiate shipping quotes for each item just as the potential buyer negotiates the item price and item quantity as described above with respect to FIG. 21. For items for which the item price, item quantity, and shipping price have been agreed to, the potential buyer may be provided with an option to purchase the item in accordance with the customer agreement that the potential buyer has reached with the wholesaler.

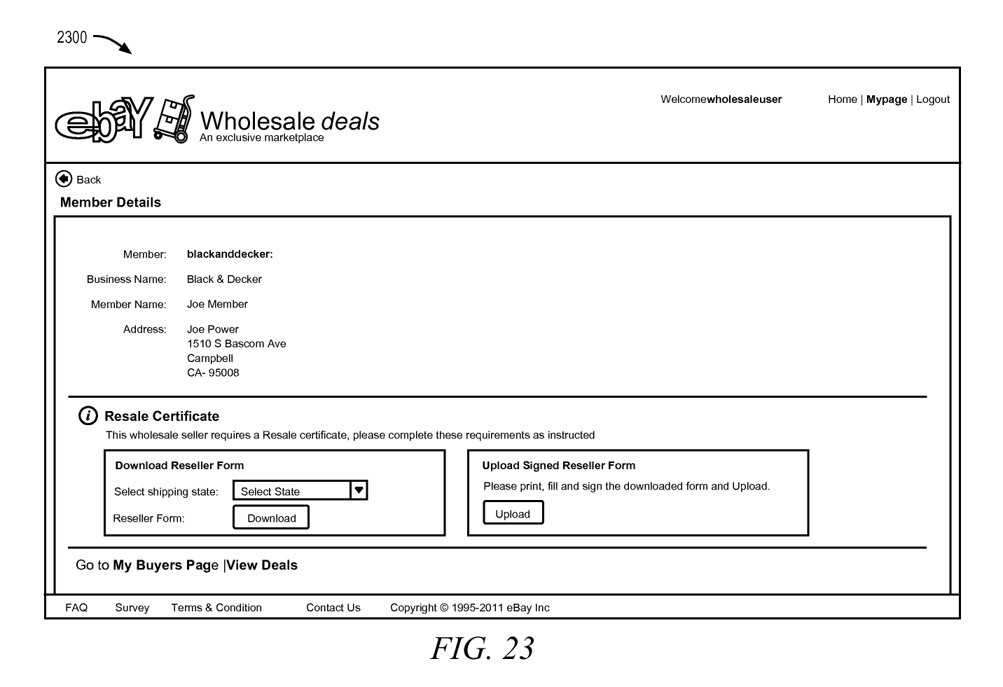

FIG. 23 is a screenshot of a portion of an example user interface 2300 that may be presented (e.g., via the user interface module 208) to a potential buyer to allow the potential buyer to provide evidence that the potential buyer is a certified reseller. In various embodiments, the user interface 2300 may allow the potential buyer to download a form corresponding to the jurisdiction (e.g., state) in which the potential buyer intends to establish that he is a certified reseller. The user interface 2300 may also allow the user to submit the printed and signed form. Based on the reception of the signed form, the vetting module 204 may authenticate the potential buyer as a reseller, as described above with respect to FIG. 8.

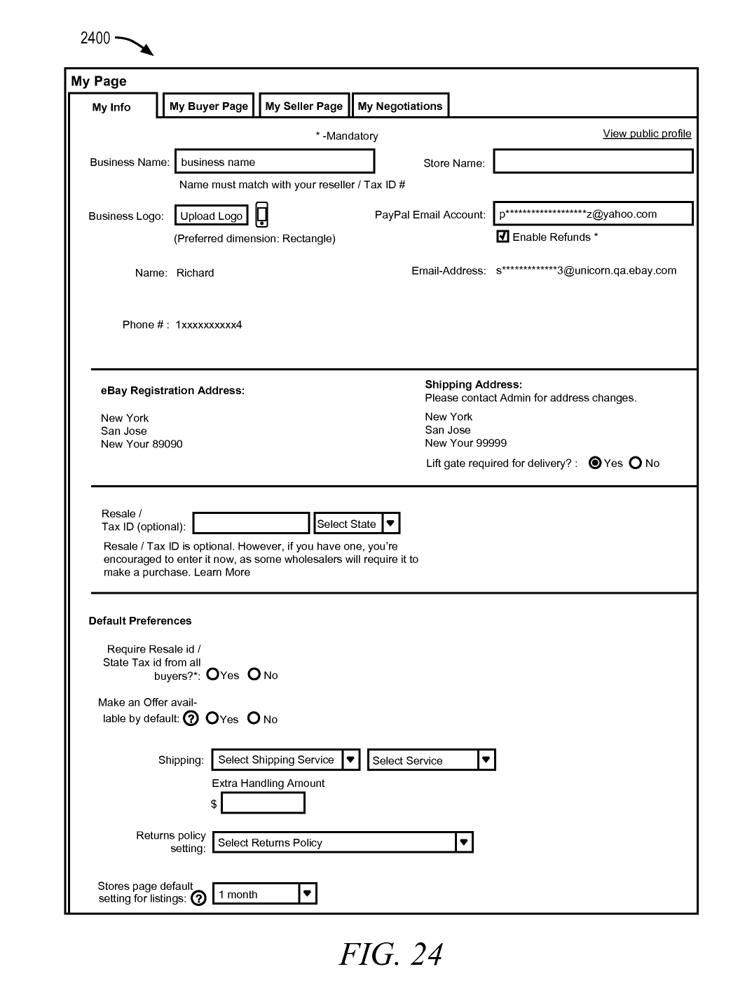

FIG. 24 is a screenshot of a portion of an example user interface 2400 that may be presented (e.g., via the user interface module 208) to a wholesaler to collect information about a wholesaler or potential buyer (e.g., via the listings module 214), such as default preferences of the wholesaler or potential buyer. For example, the user interface 2400 may allow the wholesaler or potential buyer to specify a business name, store name, logo, representative, PayPal Email Account, Email address, phone number, shipping address, registration address, and so on. Additionally, the user interface 2400 may allow the wholesaler or potential buyer to specify a resale or Tax ID. This resale or Tax ID may be authenticated by the vetting module 204, as described above with respect to FIG. 9, before allowing the wholesaler or potential buyer to make deals on the online marketplace. Examples of default preferences that the wholesaler or potential buyer may specify include whether to require a resale ID or State Tax ID from all buyers by default, whether to allow “make an offer” negotiations by default, a default shipping service, a default extra handling amount, a default returns policy, and a default expiration period for listings to appear on a store page associated with the wholesaler. These default preferences may each be overridden by information supplied by the wholesaler during the process of listing a particular item.

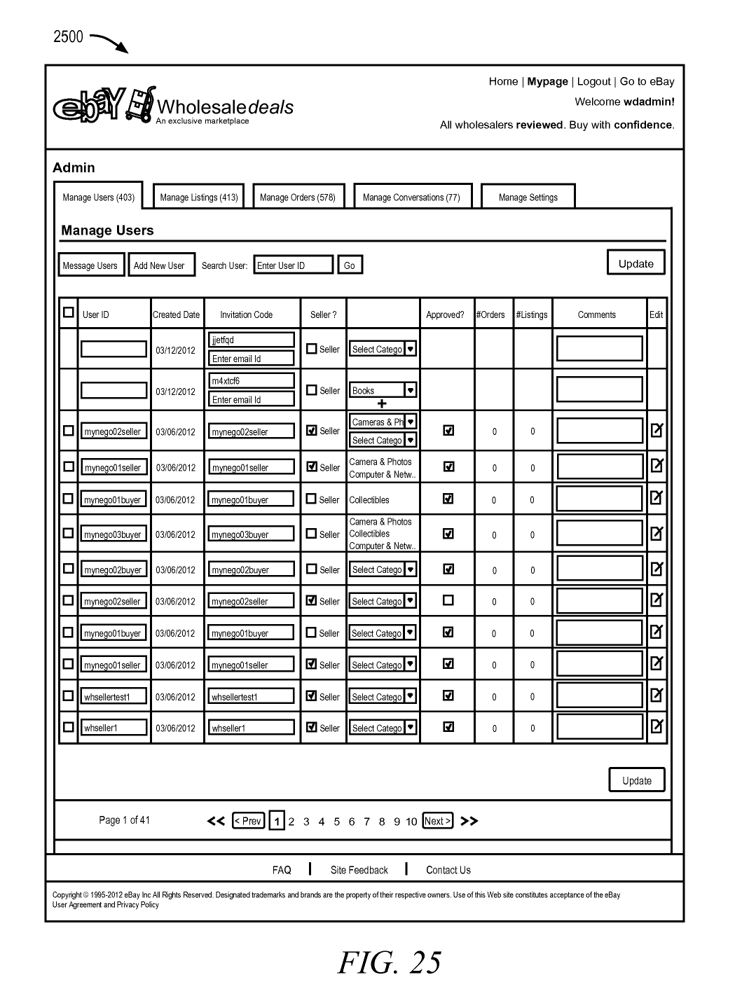

FIG. 25 is a screenshot of a portion of an example user interface 2500 that may be presented (e.g., via the user interface module 208) to allow an administrator to manage users with respect to the online marketplace system (e.g., via the administration module 220). The actions performed by the administrator using the administration module 220 may override actions performed automatically by other modules of the applications 120. The user interface 2500 may include an invitation code that is generated automatically by the administration module 220 or manually entered by the administrator. The user interface 2500 may allow the administrator to specify information about the user, such as whether the user is a seller (e.g., a wholesaler), which categories of items the user is associated with, whether the user is an approved user, and so on.

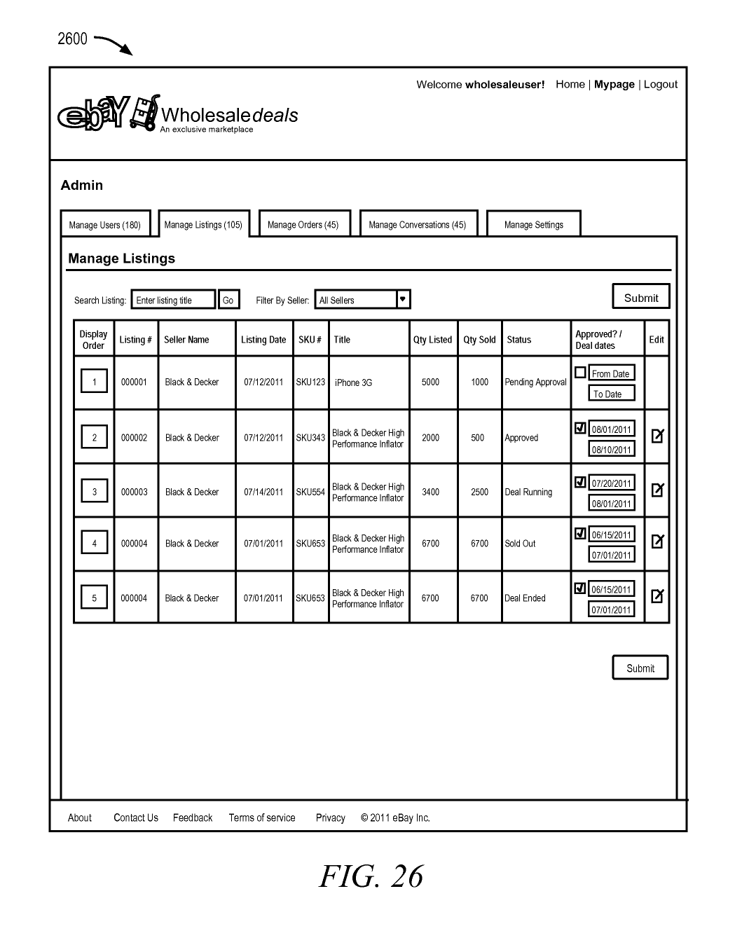

FIG. 26 is a screenshot of a portion of an example user interface 2600 that may be presented (e.g., via the user interface module 208) to allow an administrator to manage listings on the online marketplace system (e.g., via the administration module 220). The actions performed by the administrator using the administration module 220 may override actions performed automatically by other modules of the applications 120. The user interface 2600 may allow the administrator to specify whether a listing is approved as a featured listing and, if so, the dates for which the approval is valid. The user interface 2600 may also provide the administrator with the ability to specify the order in which the listings are displayed to potential buyers. Thus, a default order that is determined automatically by another module of the applications 120 may be overridden manually by the administrator. The user interface 2600 may convey other information to the administrator regarding each listing, such as the listing number, seller name, date of first posting, SKU number, title, quantity listed, quantity sold, or status (e.g., pending approval, approved, deal running, sold out, deal ended, etc.), and so on.

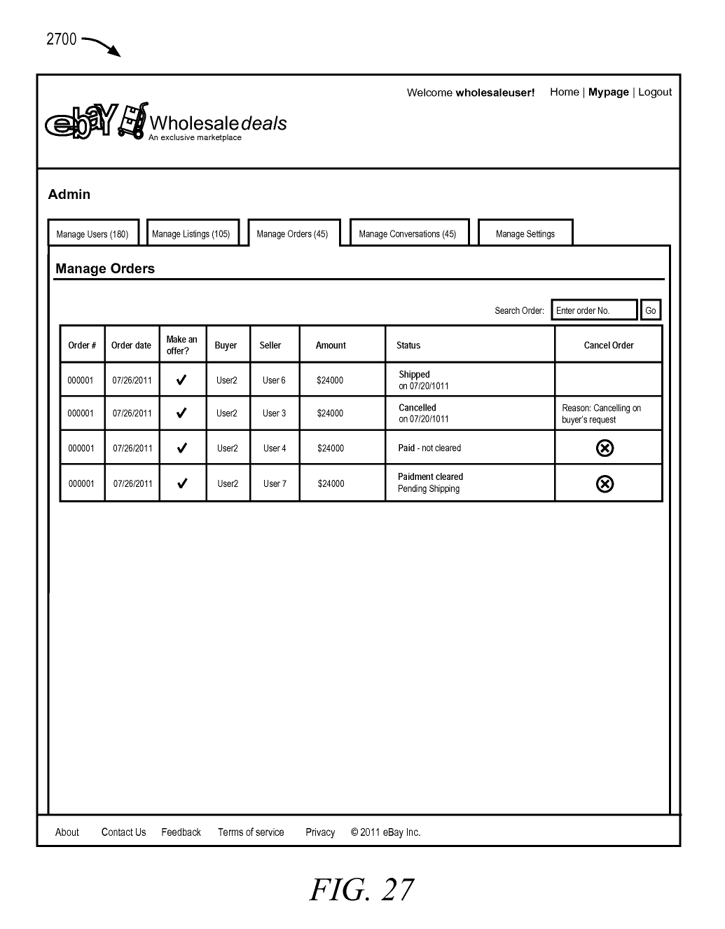

FIG. 27 is a screenshot of a portion of an example user interface 2700 that may be presented (e.g., via the user interface module 208) to allow an administrator to manage orders on the online marketplace system (e.g., via the administration module 220). The user interface 2700 may allow an administrator to cancel an order as well as specify a reason for canceling the order. The user interface 2700 may also convey information to the administrator regarding each order, such as the order number, order date, whether the “make an offer” option was enabled for the order, the name of the buyer, the name of the seller, an amount of the order, a status of the order (e.g., shipped, canceled, paid/payment not cleared, paid/payment cleared, etc.), corresponding dates of any changes to the status of the order, and so on.

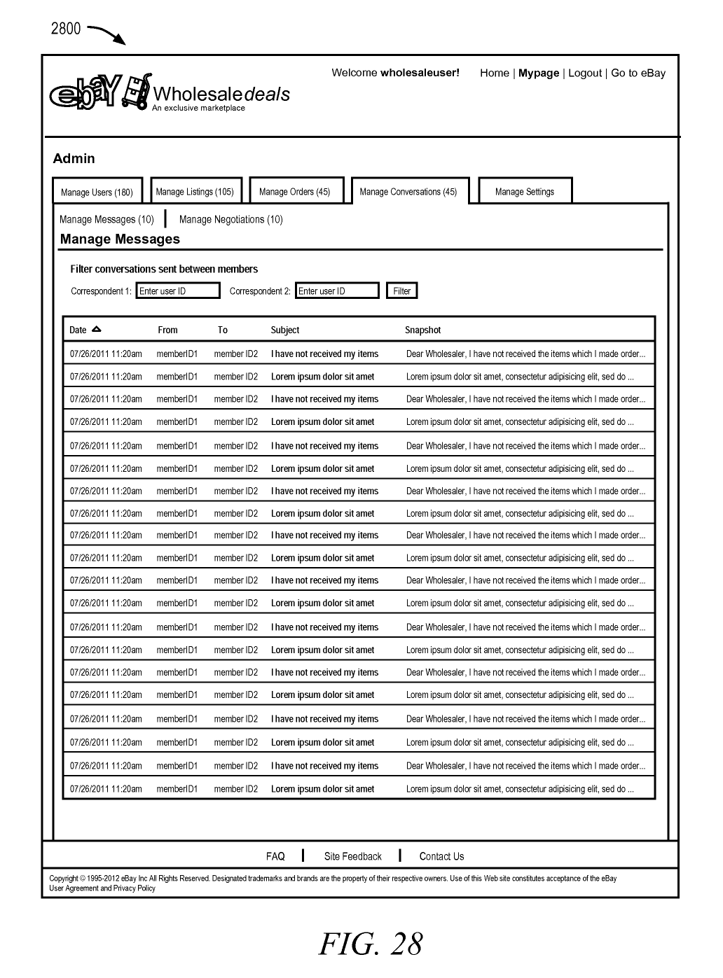

FIG. 28 is a screenshot of a portion of an example user interface 2800 that may be presented (e.g., via the user interface module 208) to allow an administrator to manage conversations (e.g., via the administration module 220). Such conversations may include messages sent between users or negotiations engaged in by the users, which are two types of conversations that may be accessible to the administrator on separate tabs of the user interface 2800. The user interface 2800 may allow the administrator to filter conversations based on keywords contained in messages sent by a first party (or correspondent) to the conversation and a second party to the conversation.

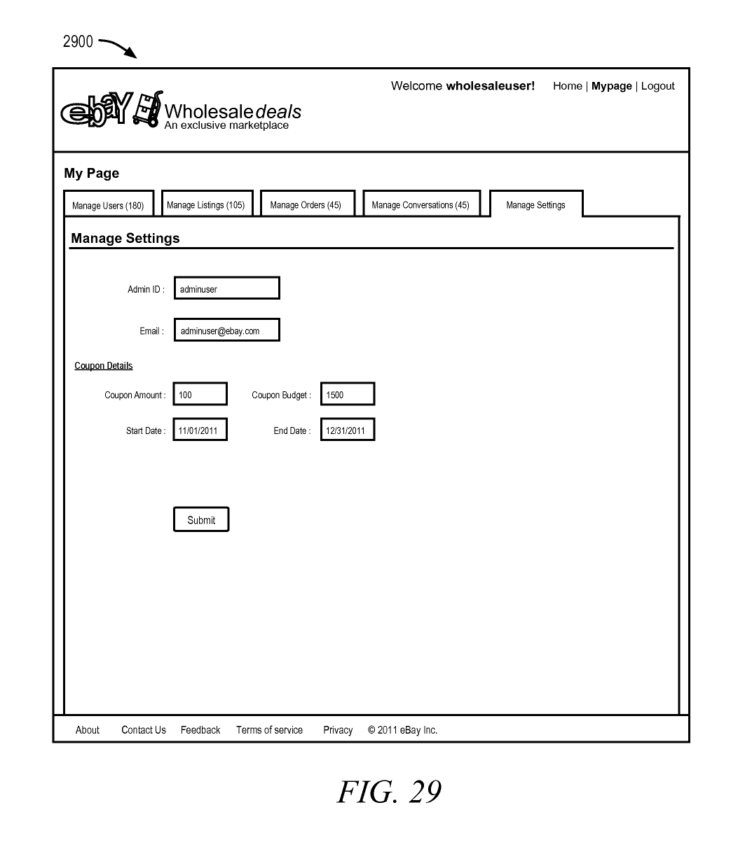

FIG. 29 is a screenshot of a portion of an example user interface 2900 that may be presented (e.g., via the user interface module 208) to allow an administrator to manage settings (e.g., via the administration module 220). For example, the user interface 2900 may allow the administrator to specify an ID and an email address. Additionally, the administrator may be able to specify or view coupon details, such as a coupon amount, coupon budget, start date, or end date for one or more items listed by wholesalers.

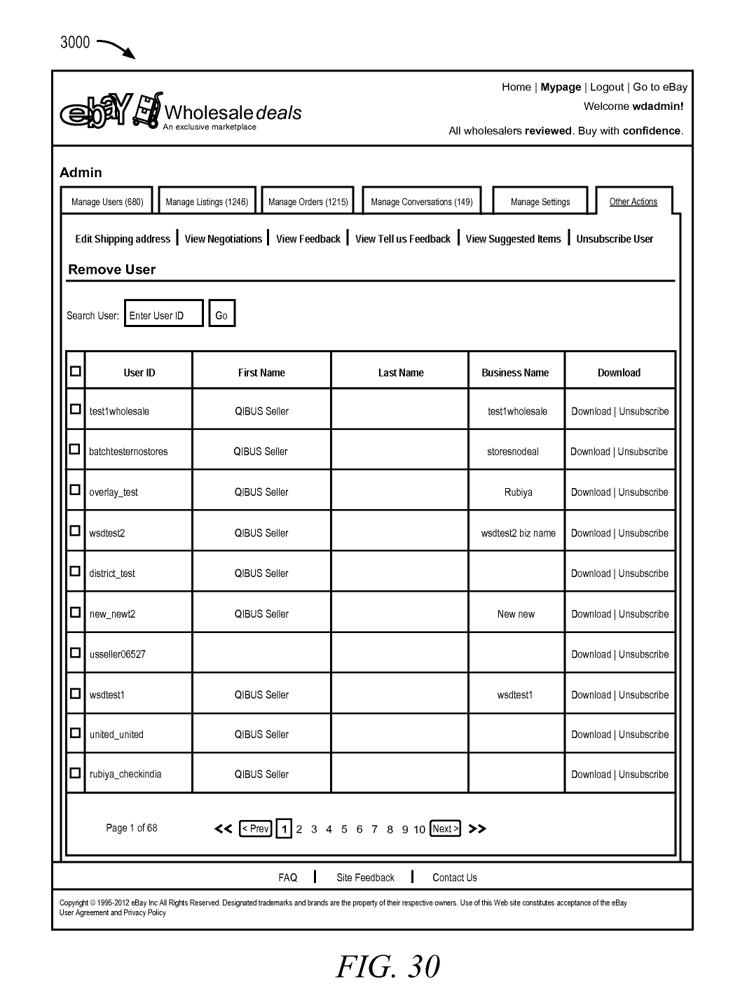

FIG. 30 is a screenshot of a portion of an example user interface 3000 that may be presented (e.g., via the user interface module 208) to allow an administrator to perform miscellaneous actions (e.g., via the administration module 220). Such miscellaneous actions may include editing a shipping address, viewing negotiations, viewing feedback, viewing suggested items, or preventing a user from accessing the online wholesale marketplace. For example, the user interface 3000 may include an Unsubscribe link in a field corresponding to each subscribed user of the online wholesale marketplace. When the administrator clicks the Unsubscribe link for a user, the vetting module 204 may prevent the user from accessing the online wholesale marketplace. The user interface 3000 may also include a Subscribe link in a field corresponding to each unsubscribed user of the online wholesale marketplace. When the administrator clicks the Subscribe link, the vetting module 204 may allow the user to access the online wholesale marketplace, assuming various other criteria for the user's access, as described above, are met.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures should be considered. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

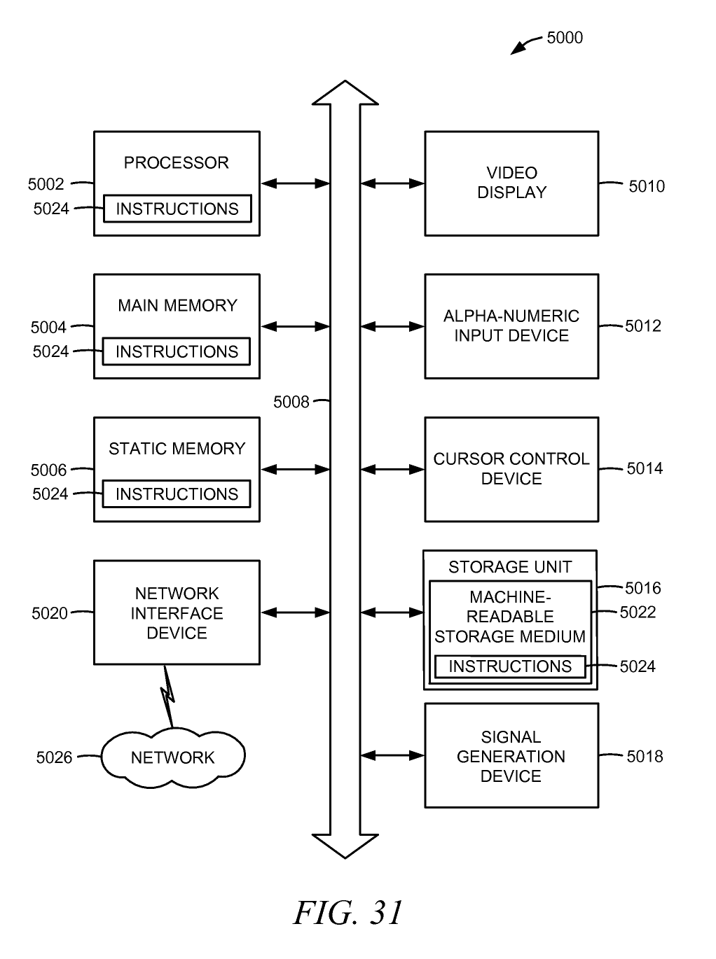

FIG. 31 is a block diagram of machine in the example form of a computer system 5000 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 5000 includes a processor 5002 (e.g., a central processing unit (CPU), a graphics processing unit (GPU) or both), a main memory 5004 and a static memory 5006, which communicate with each other via a bus 5008. The computer system 5000 may further include a video display unit 5010 (e.g., a liquid crystal display (LCD) or a cathode ray tube (CRT)). The computer system 5000 also includes an alphanumeric input device 5012 (e.g., a keyboard), a user interface (UI) navigation (or cursor control) device 5014 (e.g., a mouse), a storage unit 5016, a signal generation device 5018 (e.g., a speaker) and a network interface device 5020.

The storage unit 5016 includes a machine-readable medium 5022 on which is stored one or more sets of data structures and instructions 5024 (e.g., software) embodying or utilized by any one or more of the methodologies or functions described herein. The instructions 5024 may also reside, completely or at least partially, within the main memory 5004 and/or within the processor 5002 during execution thereof by the computer system 5000, the main memory 5004 and the processor 5002 also constituting machine-readable media. The instructions 5024 may also reside, completely or at least partially, within the static memory 5006.

While the machine-readable medium 5022 is shown in an example embodiment to be a single medium, the term “machine-readable medium” may include a single medium or multiple media (e.g., a centralized or distributed database, and/or associated caches and servers) that store the one or more instructions 5024 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 5024 may further be transmitted or received over a communications network 5026 using a transmission medium. The instructions 5024 may be transmitted using the network interface device 5020 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 5026 may be the same as network 104 of FIG. 1.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to allow those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving a notification that a wholesaler of an item intends to sell the item on an online marketplace, the online marketplace reserved for wholesaling, the notification including a price at which the wholesaler intends to sell the item;
comparing the price at which the wholesaler intends to sell the item with an average price at which an end consumer may purchase the item on an additional online marketplace, the additional online marketplace not reserved for wholesaling; and
using one or more processors, receiving a listing from the wholesaler of the item based on the comparison of the price at which the wholesaler intends to sell the item being less than the average price at which the end consumer may purchase the item on the additional online marketplace.

2. The method of claim 1, further comprising allowing a potential buyer of the item on the online marketplace to confirm the average price at which the end consumer may purchase the item on the additional online marketplace by clicking a user interface element associated with a listing of the item on the online marketplace.

3. The method of claim 2, wherein the allowing of the potential buyer of the item on the online marketplace to confirm the average price at which the end consumer may purchase the item on the additional online marketplace includes displaying a summary of prices at which the item was sold on the additional online marketplace by navigating to the online marketplace via a web browser using an HTTP request.

4. The method of claim 1, further comprising determining that a potential buyer is a top seller of the item to end consumers on the additional online marketplace and providing the potential buyer with access to the online marketplace based on the determination.

5. The method of claim 1, further comprising allowing a potential buyer to engage in a number of rounds of negotiations with the wholesaler regarding an offer, each of the number of rounds allowing one of the potential buyer and the wholesaler to specify at least one of a new price and a new quantity for the item, the number of rounds of negotiations being specified by the wholesaler.

6. The method of claim 5, further comprising ending the rounds of negotiations based on the number of rounds of negotiations concluding without an agreement being reached between the potential buyer and the wholesaler on at least one of a final quantity and a final price for the item.

7. The method of claim 5, further comprising allowing the potential buyer to engage in the number of rounds of the negotiations with the wholesaler based on an authentication of the potential buyer as a certified reseller.

8. A system comprising:
a processor-implemented module configured to:
receive a notification that a wholesaler of an item intends to sell the item on an online marketplace, the online marketplace reserved for wholesaling, the notification including a price at which the wholesaler intends to sell the item;
compare the price at which the wholesaler intends to sell the item with an average price at which an end consumer may purchase the item on an additional online marketplace, the additional online marketplace not reserved for wholesaling; and
allow receiving a listing from the wholesaler of the item based on the comparison of the price at which the wholesaler intends to sell the item being less than the average price at which the end consumer may purchase the item on the additional online marketplace.

9. The system of claim 8, wherein the processor-implemented module is further configured to allow a potential buyer of the item on the online marketplace to confirm the average price at which the end consumer may purchase the item on the additional online marketplace by clicking a user interface element associated with a listing of the item on the online marketplace.

10. The system of claim 9, wherein the processor-implemented module is further configured to allow the potential buyer of the item on the online marketplace to confirm the average price at which the end consumer may purchase the item on the additional online marketplace includes displaying a summary of prices at which the item was sold on the additional online marketplace by navigating to the online marketplace via a web browser using an HTTP request.

11. The system of claim 8, the processor-implemented module further configured to determine that a potential buyer is a top seller of the item to end consumers on the additional online marketplace and providing the potential buyer with access to the online marketplace based on the determination.

12. The system of claim 8, the processor-implemented module further configured to allow a potential buyer to engage in a number of rounds of negotiations with the wholesaler regarding an offer, each of the number of rounds allowing one of the potential buyer and the wholesaler to specify at least one of a new price and a new quantity for the item, the number of rounds of negotiations being specified by the wholesaler.

13. The system of claim 12, the processor-implemented module further configured to end the rounds of negotiations based on the number of rounds of negotiations concluding without an agreement being reached between the potential buyer and the wholesaler on at least one of a final quantity and a final price for the item.

14. The system of claim 12, the processor-implemented module further configured to allow the potential buyer to engage in the number of rounds of the negotiations with the wholesaler based on an authentication of the potential buyer as a certified reseller.

15. A non-transitory machine-readable medium embodying a set of instructions that, when executed by a processor, causes the processor to perform a method comprising:
receiving a notification that a wholesaler of an item intends to sell the item on an online marketplace, the online marketplace reserved for wholesaling, the notification including a price at which the wholesaler intends to sell the item;
comparing the price at which the wholesaler intends to sell the item with an average price at which an end consumer may purchase the item on an additional online marketplace, the additional online marketplace not reserved for wholesaling; and
receiving a listing from the wholesaler of the item based on the comparison of the price at which the wholesaler intends to sell the item being less than the average price at which the end consumer may purchase the item on the additional online marketplace.

16. The non-transitory machine readable medium of claim 15, further comprising allowing a potential buyer of the item on the online marketplace to confirm the average price at which the end consumer may purchase the item on the additional online marketplace by clicking a user interface element associated with a listing of the item on the online marketplace.

17. The non-transitory machine readable medium of claim 16, wherein the allowing of the potential buyer of the item on the online marketplace to confirm the average price at which the end consumer may purchase the item on the additional online marketplace includes displaying a summary of prices at which the item was sold on the additional online marketplace by navigating to the online marketplace via a web browser using an HTTP request.

18. The non-transitory machine readable medium of claim 15, further comprising determining that a potential buyer is a top seller of the item to end consumers on the additional online marketplace and providing the potential buyer with access to the online marketplace based on the determination.

19. The non-transitory machine readable medium of claim 15, further comprising allowing a potential buyer to engage in a number of rounds of negotiations with the wholesaler regarding an offer, each of the number of rounds allowing one of the potential buyer and the wholesaler to specify at least one of a new price and a new quantity for the item, the number of rounds of negotiations being specified by the wholesaler.

20. The non-transitory machine readable medium of claim 19, further comprising ending the rounds of negotiations based on the number of rounds of negotiations concluding without an agreement being reached between the potential buyer and the wholesaler on at least one of a final quantity and a final price for the item.
